(19) United States
(12) Patent Application Publication
(10) Pub. No.: US 2023/0083293 A1
(43) Pub. Date: Mar. 16, 2023

(54) SYSTEMS AND METHODS FOR DETECTING GLASS AND SPECULAR SURFACES FOR ROBOTS

(71) Applicant: Brain Corporation, San Diego, CA (US)

(72) Inventor: Mengze Xu, San Diego, CA (US)

(21) Appl. No.: 17/986,224

(22) Filed: Nov. 14, 2022

Related U.S. Application Data
(63) Continuation of application No. PCT/US21/32696, filed on May 17, 2021.
(60) Provisional application No. 63/025,670, filed on May 15, 2020.

(51) Int. Cl. G01S 7/4861; G01S 17/931; G05D 1/02; G06T 17/00

(52) U.S. Cl. CPC G01S 7/4861; G01S 17/931; G05D 1/0242; G05D 1/0238; G06T 17/00; G06T 2207/10028

(57) ABSTRACT

Systems and methods for detecting glass for robots are disclosed herein. According to at least one non-limiting exemplary embodiment, a method for detecting glass objects using a LiDAR or light based time-of-flight (“ToF”) sensor is disclosed. According to at least one non-limiting exemplary embodiment, a method for detecting glass objects using an image sensor is disclosed. Both methods may be used in conjunction to enable a robot to quickly detect, verify, and map glass objects on a computer readable map.

### PRIORITY

This application is a continuation of International Patent Application No. PCT/US21/32696, filed on May 17, 2021 and claims the benefit of U.S. Provisional Patent Application Ser. No. 63/025,670 filed on May 15, 2020 under 35 U.S.C. § 119, the entire disclosure of each is incorporated herein by reference.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### SUMMARY

The present application relates generally to robotics, and more specifically to systems and methods for detection of transparent, glass and specular surfaces for robots or autonomous devices.

The needs in the conventional technology are satisfied by the present disclosure, which provides for, inter alia, systems and methods for detection of glass for robots. The present disclosure is directed towards a practical application of detecting glass and specular surfaces for use by robots to plan routes and avoid collision with objects that typical LiDAR and time-of-flight sensors struggle to detect.

Exemplary embodiments described herein have innovative features, no single one of which is indispensable or solely responsible for their desirable attributes. Without limiting the scope of the claims, some of the advantageous features will be summarized. One skilled in the art would appreciate that, as used herein, the term robot may generally refer to an autonomous vehicle or object that travels a route, executes a task, or otherwise moves automatically upon executing or processing computer-readable instructions.

According to at least one non-limiting exemplary embodiment, a method for detecting glass and specular surfaces using a time-of-flight (“ToF”) sensor is disclosed herein. The method comprises a controller of a robot, collecting measurements using a sensor as a robot navigates along a route in an environment, the measurements comprising a plurality of points localized on a computer-readable map; identifying one or more first points of the measurements based on a first threshold; identifying one or more of the first points of the measurement as an object based on a second threshold value, the object comprises glass or specular surfaces; and updating the computer-readable map to comprise the object in the environment.

According to at least one non-limiting exemplary embodiment, the method further comprises the controller, discretizing the computer-readable map into a plurality of angular bins, each angular bin comprising an arc length defined about an origin, the origin comprising a fixed point within an environment; populating each angular bin of the plurality of angular bins with a summation of distances between the one or more first points encompassed therein and the origin; and comparing the summation of distances for each angular bin to the second threshold value, the one or more first points encompassed within each angular bin are identified as representing the object upon the summation of distances exceeding the second threshold value for a respective angular bin.

According to at least one non-limiting exemplary embodiment, the first threshold comprises a first angular range and a second angular range, the one or more first points are identified from the plurality of points based on a lack of detection of points within the first angular range, and the one or more first points are within the second angular range, the second angular range being encompassed within the first angular range.

According to at least one non-limiting exemplary embodiment, the method may further comprise sweeping the first and second angular ranges of the first threshold about a local sensor origin of the one or more sensors; and identifying the one or more first points based on the first threshold at various angles about the local sensor origin.

According to at least one non-limiting exemplary embodiment, the first threshold comprises a spatial separation between points of a first scan and points of a second scan, points of the first scan being separated by the spatial separation to points of the second scan corresponds to the points of the first scan and points of the second scan comprising the one or more first points, the second scan being subsequent to the first scan, the spatial separation being based on a speed of the robot and a sampling or scan rate of the sensor.

According to at least one non-limiting exemplary embodiment, the one or more identified first points are separated apart from each other at a greater distance compared to separation between other points of the plurality of points, the first points corresponding to the object and the other points corresponding to another object, the another object corresponding to non-glass or non-specular surface.

According to at least one non-limiting exemplary embodiment, the one or more identified first points include a density lower than density of the other points of the plurality of points.

According to at least one non-limiting exemplary embodiment, the method may further comprise navigating the robot to the object based on the computer-readable map; and utilizing a camera sensor to detect a reflection of the robot to verify the one or more objects comprising glass or specular surfaces.

According to at least one non-limiting exemplary embodiment, the method may further comprise the robot performing a visual display upon navigating the robot to the object; and detecting a reflection of the visual display using the camera sensor to verify the one or more objects comprising glass or specular surfaces.

According to at least one non-limiting exemplary embodiment, the identification of the one or more first points is performed after the robot has navigated the route based on a computer-readable map generated at least in part during navigation of the route.

According to at least one non-limiting exemplary embodiment, the identification of the one or more first points is performed after the robot has navigated the route based on a computer-readable map generated at least in part during navigation of the route.

According to at least one non-limiting exemplary embodiment, the identification of the one or more first points is performed after the robot has navigated the route based on a computer-readable map generated at least in part during navigation of the route.

According to at least one non-limiting exemplary embodiment, a non-transitory computer-readable storage medium is disclosed herein. The non-transitory computer-readable storage medium may comprise a plurality of computer-readable instructions embodied thereon that, when executed by one or more processors, configure the one or more processors to, collect measurements using a sensor as the robot navigates a route, the measurements comprising a plurality of points localized on a computer-readable map; identify one or more first points of the measurements based on a first threshold; discretize the computer-readable map into a plurality of angular bins, each angular bin comprising an arc length defined about an origin, the origin comprising a fixed point within an environment; populate each angular bin of the plurality with a summation of distances between each of the one or more first points encompassed therein and the origin; compare the summation of distances for each angular bin to a threshold value, the one or more first points encompassed within each angular bin are identified as representing one or more objects upon the summation of distances exceeding the threshold value for a respective angular bin, the one or more objects comprising glass or specular surfaces; and update the computer-readable map to comprise the one or more objects.

According to at least one non-limiting exemplary embodiment, the first threshold comprises a first angular range and a second angular range, the one or more first points are identified based on a lack of detection of points within the first angular range and the one or more first points are within the second angular range, the second angular range being encompassed within the first angular range.

According to at least one non-limiting exemplary embodiment, the non-transitory computer-readable storage medium may further include computer-readable instructions that configure the one or more processors to sweep the first and second angular ranges of the first threshold about a local sensor origin of the sensor; and identify the one or more first points based on the first threshold at various angles about the local sensor origin.

According to at least one non-limiting exemplary embodiment, the first threshold comprises a spatial separation between points of a first scan and points of a second scan, detection of points of the first scan being separated by the spatial separation to points of the second scan corresponds to the points of the first scan and points of the second scan comprising suspicious points, the second scan being subsequent to the first scan, the spatial separation being based on a speed of the robot and a sampling or scan rate of the sensor.

According to at least one non-limiting exemplary embodiment, the non-transitory computer-readable storage medium may further include computer-readable instructions that configure the one or more processors to navigate the robot to the one or more objects based on the computer-readable map and utilize a camera sensor to detect a reflection of the robot to verify the one or more objects comprising glass or specular surfaces.

According to at least one non-limiting exemplary embodiment, the non-transitory computer-readable storage medium may further include computer-readable instructions that configure the one or more processors to configure the robot to perform a visual display upon navigating the robot to the one or more objects, and detect a reflection of the visual display using the camera sensor to verify the one or more objects comprising glass or specular surfaces.

According to at least one non-limiting exemplary embodiment, a method for detecting glass and specular surfaces is disclosed. The method may comprise a robot, collecting images using a camera sensor as the robot navigates a route; detecting a reflection of the robot within one or more images; and performing a visual display, wherein the detection of the visual display within images from the camera sensor correspond to detection of a glass object or reflective surface.

According to at least one non-limiting exemplary embodiment, the visual display comprises at least one of the robot blinking or changing colors of one or more lights, or moving a feature of the robot.

According to at least one non-limiting exemplary embodiment, detection of the reflection comprises use of an image-recognition algorithm to identify images comprising of, at least in part, the robot.

According to at least one non-limiting exemplary embodiment, the method may further comprise the robot producing a computer-readable map of an environment of the robot, the computer-readable map comprising the glass object or reflective surface localized thereon.

These and other objects, features, and characteristics of the present disclosure, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure. As used in the specification and in the claims, the singular form of “a,” “an,” and “the” include plural referents unless the context clearly dictates otherwise.

### BRIEF DESCRIPTION OF THE DRAWINGS

The disclosed aspects will hereinafter be described in conjunction with the appended drawings, provided to illustrate and not to limit the disclosed aspects, wherein like designations denote like elements.

FIG. 1A is a functional block diagram of a main robot in accordance with some embodiments of this disclosure.

FIG. 1B is a functional block diagram of a controller or processor in accordance with some embodiments of this disclosure.

FIG. 2A(i)-(ii) illustrates a LiDAR or ToF sensor and a point cloud generated from the sensor in accordance with some embodiments of this disclosure.

FIG. 2B(i-ii) illustrates a difference between diffuse reflection and specular reflection, in accordance with some embodiments of this disclosure.

FIG. 3A-B illustrates behavior of beams of a ToF sensor when incident upon a glass surface, according to an exemplary embodiment.

FIG. 4A-B illustrates a robot utilizing a ToF sensor to detect glass, according to an exemplary embodiment.

FIG. 5 illustrates thresholds used to identify suspicious points, suspicious points potentially including localized points of a glass surface, according to an exemplary embodiment.

FIG. 6 illustrates thresholds used to identify suspicious points, according to an exemplary embodiment.

FIG. 7A illustrates a computer-readable map comprising suspicious points localized therein, according to an exemplary embodiment.

FIG. 7B illustrates angular bins utilized in conjunction with a threshold to determine if suspicious points of the map illustrated in FIG. 7A comprise glass, according to an exemplary embodiment.

FIG. 7C illustrates a computer-readable map comprising glass objects localized thereon, according to an exemplary embodiment.

FIG. 8 illustrates a method for detection of glass or verification of the detection of glass using specular reflection, according to an exemplary embodiment.

FIG. 9 is a process-flow diagram illustrating a method for a robot to detect glass using a ToF sensor, according to an exemplary embodiment.

FIG. 10 is a process-flow diagram illustrating a method for a robot to detect glass using an image sensor or camera, according to an exemplary embodiment.

All Figures disclosed herein are © Copyright 2020 Brain Corporation. All rights reserved.

### DETAILED DESCRIPTION

Currently, robots may utilize various light detection and ranging (“LiDAR”) sensors such as scanning LiDAR sensors, structured light sensors, depth cameras, and/or other time-of-flight (“ToF”) sensors. These LiDAR and ToF sensors utilize beams of light emitted by these sensors, which diffusely reflect off surfaces back to a detector of the sensor. Glass, as well as other reflective surfaces such as metal and smooth white walls, may not diffusely reflect these beams, thereby making detection of glass or reflective surfaces difficult for LiDAR and ToF sensors. Conventional technology provides one method of detecting glass using a return signal strength of emitted light from a sensor. However, sensors configurable to measure signal strength with sufficient accuracy to detect a glass surface may be very costly for manufacturers of robots. Additionally, the use of return signal strength from a LiDAR or ToF sensor is further influenced by an environment of a robot (e.g., ambient lighting, distance to the glass/reflective surface, thickness of glass, etc.) that may affect signal strength, thereby making the method unreliable in many environments.

Detection of glass may be critical for safe operation of robots operating within environments comprising glass walls, windows, or mirrors. Failure to detect a glass wall may cause collision with the robot and the glass wall or potentially shatter or crack the glass wall and/or damage the robot. Highly transparent objects, such as glass, may pose a risk to robots using LiDAR and/or ToF sensors as these sensors may rely on diffuse reflection of beams off objects, wherein highly transparent objects may exhibit specular reflection or may transmit the beams through the objects, which may cause difficulties for a robot to localize these objects. Accordingly, there is a need in the art for systems and methods for detection of glass and specular surfaces for robots.

Various aspects of the novel systems, apparatuses, and methods disclosed herein are described more fully hereinafter with reference to the accompanying drawings to address the issues present in conventional technology. This disclosure can, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art would appreciate that the scope of the disclosure is intended to cover any aspect of the novel systems, apparatuses, and methods disclosed herein, whether implemented independently of, or combined with, any other aspect of the disclosure. For example, an apparatus may be implemented or a method may be practiced using any number of the aspects set forth herein. In addition, the scope of the disclosure is intended to cover such an apparatus or method that is practiced using other structure, functionality, or structure and functionality in addition to or other than the various aspects of the disclosure set forth herein. It should be understood that any aspect disclosed herein may be implemented by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, and/or objectives. The detailed description and drawings are merely illustrative of the disclosure rather than limiting, the scope of the disclosure being defined by the appended claims and equivalents thereof.

The present disclosure provides for systems and methods of glass detection for robots. As used herein, a robot may include mechanical and/or virtual entities configured to carry out a complex series of tasks or actions autonomously. In some exemplary embodiments, robots may be machines that are guided and/or instructed by computer programs and/or electronic circuitry. In some exemplary embodiments, robots may include electro-mechanical components that are configured for navigation, where the robot may move from one location to another. Such robots may include autonomous and/or semi-autonomous cars, floor cleaners, rovers, drones, planes, boats, carts, trams, wheelchairs, industrial equipment, stocking machines, mobile platforms, personal transportation devices (e.g., hover boards, scooters, self-balancing vehicles such as manufactured by Segway®, etc.), trailer movers, vehicles, and the like. Robots may also include any autonomous and/or semi-autonomous machine for transporting items, people, animals, cargo, freight, objects, luggage, and/or anything desirable from one location to another.

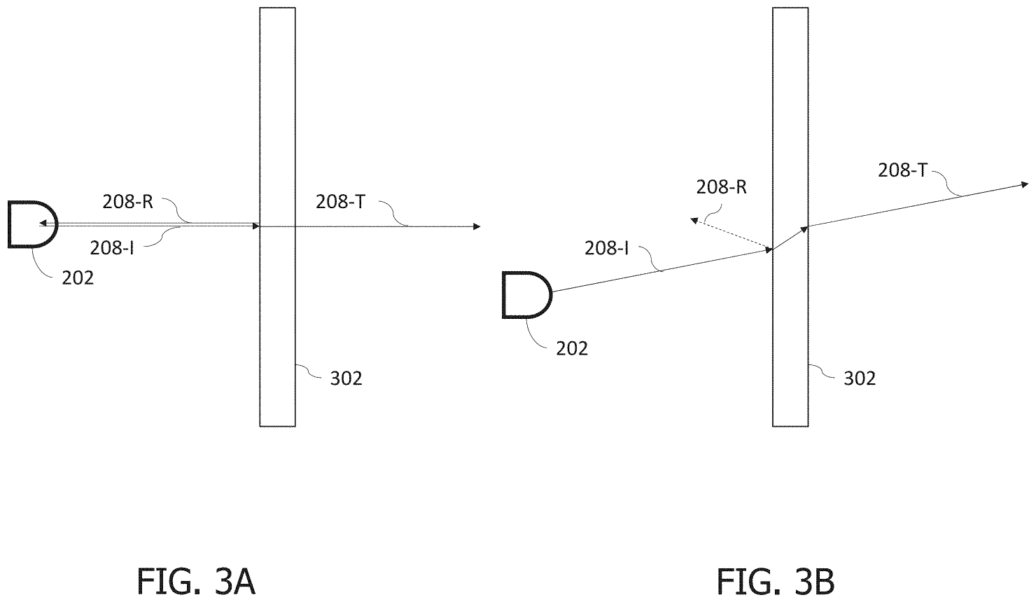

As used herein, a glass object may comprise any material that is substantially transparent (e.g., 20% transmissivity, or greater) to a wavelength of light in at least one of the infrared, visible, ultraviolet wavelengths, or other wavelength of light used by sensors of a robot. Glass objects may comprise objects (e.g., glass cups, statues, etc.) or surfaces (e.g., windows). One skilled in the art may appreciate that the systems and methods disclosed herein may be similarly applied to objects which are opaque in the visible light bandwidth but substantially transparent in the wavelength of a sensor used to sense the objects (e.g., transparent to infrared for scanning LiDAR sensors). Substantially transparent, as used herein, may similarly be used to describe any surface or object which is difficult to detect using a time-of-flight sensor at any other angle than normal incidence, as illustrated in FIG. 3A-B below, due to high transmissivity of the object (e.g., glass) which causes beams emitted from the sensor to transmit a majority of its energy through the object.

As used herein, a specular object or surface may comprise an object or surface that exhibits specular reflection, such as mirrors, metallic surfaces, glass (in some instances, as described in FIG. 3A-B), and/or substantially smooth surfaces (e.g., glossy walls). In some instances, specular objects and/or surfaces may further comprise a high reflectivity. That is, specular objects or surfaces may include any object or surface of which a beam of light incident upon the objects or surfaces at an angle reflects therefrom at the same angle.

As used herein, network interfaces may include any signal, data, or software interface with a component, network, or process including, without limitation, those of the FireWire (e.g., FW400, FW800, FWS800T, FWS1600, FWS3200, etc.), universal serial bus (“USB”) (e.g., USB 1.X, USB 2.0, USB 3.0, USB Type-C, etc.), Ethernet (e.g., 10/100, 10/100/1000 (Gigabit Ethernet), 10-Gig-E, etc.), multimedia over coax alliance technology (“MoCA”), Coaxsys (e.g., TVNET™), radio frequency tuner (e.g., in-band or OOB, cable modem, etc.), Wi-Fi (802.11), WiMAX (e.g., WiMAX (802.16)), PAN (e.g., PAN/802.15), cellular (e.g., 3G, LTE/LTE-A/TD-LTE/TD-LTE, GSM, etc.), IrDA families, etc. As used herein, Wi-Fi may include one or more of IEEE-Std. 802.11, variants of IEEE-Std. 802.11, standards related to IEEE-Std. 802.11 (e.g., 802.11 a/b/g/n/ac/ad/af/ah/ai/aj/aq/ax/ay), and/or other wireless standards.

As used herein, controller, controlling device, processor, processing device, microprocessing device, and/or digital processing device may include any type of digital processing device such as, without limitation, digital signal processing devices (“DSPs”), reduced instruction set computers (“RISC”), complex instruction set computers (“CISC”), microprocessing devices, gate arrays (e.g., field programmable gate arrays (“FPGAs”)), programmable logic device (“PLDs”), reconfigurable computer fabrics (“RCFs”), array processing devices, secure microprocessing devices, and application-specific integrated circuits (“ASICs”). Such digital processing devices may be contained on a single unitary integrated circuit die or distributed across multiple components.

As used herein, a computer program and/or software may include any sequence of machine-cognizable steps that perform a function. Such computer program and/or software may be rendered in any programming language or environment including, for example, C/C++, C#, Fortran, COBOL, MATLAB™, PASCAL, GO, RUST, SCALA, Python, assembly language, markup languages (e.g., HTML, SGML, XML, VoXML) and the like, as well as object-oriented environments such as the Common Object Request Broker Architecture (“CORBA”), JAVA™ (including J2ME, Java Beans, etc.), Binary Runtime Environment (e.g., “BREW”) and the like.

As used herein, connection, link, and/or wireless link may include a causal link between any two or more entities (whether physical or logical/virtual), which enables information exchange between the entities.

As used herein, a computer and/or computing device may include, but are not limited to, personal computers (“PCs”) and minicomputers, whether desktop, laptop, or otherwise, mainframe computers, workstations, servers, personal digital assistants (“PDAs”), handheld computers, embedded computers, programmable logic devices, personal communicators, tablet computers, mobile devices, portable navigation aids, J2ME equipped devices, cellular telephones, smart phones, personal integrated communication or entertainment devices, and/or any other device capable of executing a set of instructions and processing an incoming data signal.

Detailed descriptions of the various embodiments of the system and methods of the disclosure are provided. While many examples discussed herein may refer to specific exemplary embodiments, it will be appreciated by one skilled in the art that the described systems and methods contained herein are applicable to any kind of robot. Myriad other embodiments or uses for the technology described herein would be readily envisaged by those having ordinary skill in the art, given the contents of the present disclosure.

Advantageously, the systems and methods of this disclosure at least, (i) enable robots to detect glass using a time-of-flight (“ToF”) sensor; (ii) enable robots to detect glass using an RGB camera sensor; (iii) improve safety of operating robots within environments comprising glass; and (iv) enhance computer-readable maps generated by robots by localizing glass objects therein. Other advantages are readily discernible by one having ordinary skill in the art given the contents of the present disclosure.

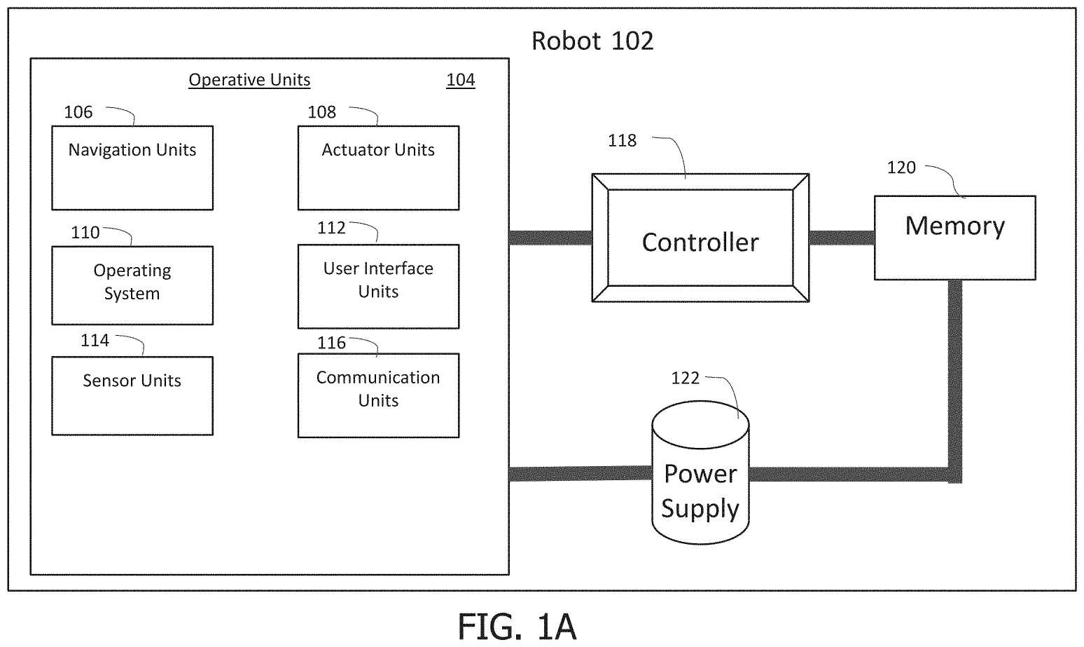

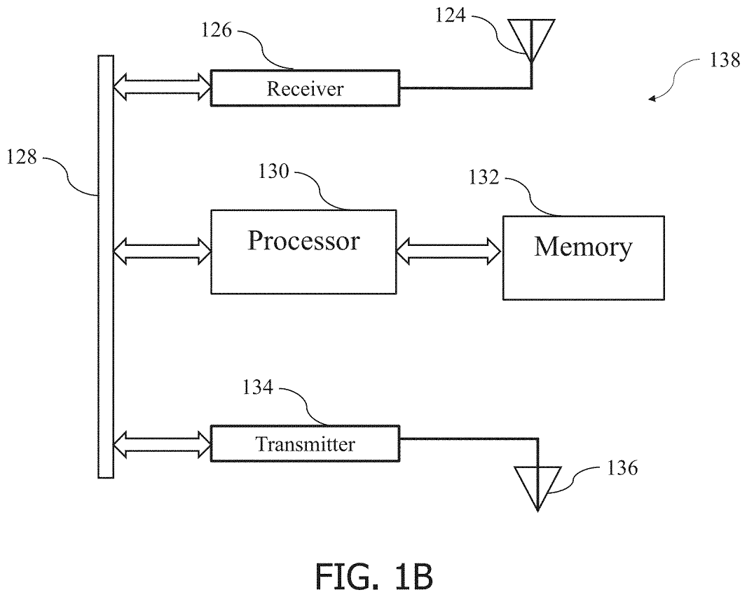

FIG. 1A is a functional block diagram of a robot 102 in accordance with some principles of this disclosure. As illustrated in FIG. 1A, robot 102 may include controller 118, memory 120, user interface unit 112, sensor units 114, navigation units 106, actuator unit 108, and communications unit 116, as well as other components and subcomponents (e.g., some of which may not be illustrated). Although a specific embodiment is illustrated in FIG. 1A, it is appreciated that the architecture may be varied in certain embodiments as would be readily apparent to one of ordinary skill given the contents of the present disclosure. As used herein, robot 102 may be representative at least in part of any robot described in this disclosure.

Controller 118 may control the various operations performed by robot 102. Controller 118 may include and/or comprise one or more processors (e.g., microprocessors) and other peripherals. As previously mentioned and used herein, a processor, microprocessor, and/or digital processor may include any type of digital processing device such as, without limitation, digital signal processors (“DSPs”), reduced instruction set computers (“RISC”), general-purpose (“CISC”) processors, microprocessors, gate arrays (e.g., field programmable gate arrays (“FPGAs”)), programmable logic device (“PLDs”), reconfigurable computer fabrics (“RCFs”), array processors, secure microprocessors, and application-specific integrated circuits (“ASICs”). Peripherals may include hardware accelerators configured to perform a specific function using hardware elements such as, without limitation, encryption/description hardware, algebraic processing devices (e.g., tensor processing units, quadratic problem solvers, multipliers, etc.), data compressors, encoders, arithmetic logic units (“ALU”) and the like. Such digital processors may be contained on a single unitary integrated circuit die, or distributed across multiple components.

Controller 118 may be operatively and/or communicatively coupled to memory 120. Memory 120 may include any type of integrated circuit or other storage device configured to store digital data including, without limitation, read-only memory (“ROM”), random access memory (“RAM”), non-volatile random access memory (“NVRAM”), programmable read-only memory (“PROM”), electrically erasable programmable read-only memory (“EEPROM”), dynamic random-access memory (“DRAM”), Mobile DRAM, synchronous DRAM (“SDRAM”), double data rate SDRAM (“DDR/2 SDRAM”), extended data output (“EDO”) RAM, fast page mode RAM (“FPM”), reduced latency DRAM (“RLDRAM”), static RAM (“SRAM”), flash memory (e.g., NAND/NOR), memristor memory, pseudostatic RAM (“PSRAM”), etc. Memory 120 may provide instructions and data to controller 118. For example, memory 120 may be a non-transitory, computer-readable storage apparatus and/or medium having a plurality of instructions stored thereon, the instructions being executable by a processing apparatus (e.g., controller 118) to operate robot 102. In some cases, the instructions may be configured to, when executed by the processing apparatus, cause the processing apparatus or device to perform the various methods, features, and/or functionality described in this disclosure. Accordingly, controller 118 may perform logical and/or arithmetic operations based on program instructions stored within memory 120. In some cases, the instructions and/or data of memory 120 may be stored in a combination of hardware, some located locally within robot 102, and some located remote from robot 102 (e.g., in a cloud, server, network, etc.).

It should be readily apparent to one of ordinary skill in the art that a processing device may be internal to or on-board a robot and/or external to robot 102 and be communicatively coupled to controller 118 of robot 102 utilizing communication units 116 wherein the external processing device may receive data from robot 102, process the data, and transmit computer-readable instructions back to controller 118. In at least one non-limiting exemplary embodiment, the processing device may be on a remote server (not shown).

In some exemplary embodiments, memory 120, shown in FIG. 1A, may store a library of sensor data. In some cases, the sensor data may be associated at least in part with the detection of objects and/or people in the environment of the robot 102. In exemplary embodiments, this library may include sensor data related to objects and/or people in different conditions, such as sensor data related to objects and/or people with different compositions (e.g., materials, reflective properties, molecular makeup, etc.), different lighting conditions, angles, sizes, distances, clarity (e.g., blurred, obstructed/occluded, partially off frame, etc.), colors, surroundings, and/or other conditions. The sensor data in the library may be taken by a sensor (e.g., a sensor of sensor units 114 or any other sensor) and/or generated automatically, such as with a computer program that is configured to generate/simulate (e.g., in a virtual world) library sensor data (e.g., which may generate/simulate these library data entirely digitally and/or beginning from actual sensor data) from different lighting conditions, angles, sizes, distances, clarity (e.g., blurred, obstructed/occluded, partially off frame, etc.), colors, surroundings, and/or other conditions. The number of images in the library may depend at least in part on one or more of the amount of available data, the variability of the surrounding environment in which robot 102 operates, the complexity of objects and/or people, the variability in appearance of objects, physical properties of robots, the characteristics of the sensors, and/or the amount of available storage space (e.g., in the library, memory 120, and/or local or remote storage). In exemplary embodiments, at least a portion of the library may be stored on a network (e.g., cloud, server, distributed network, etc.) and/or may not be stored completely within memory 120. As yet another exemplary embodiment, various robots (e.g., that are commonly associated, such as robots by a common manufacturer, user, network, etc.) may be networked so that data captured by individual robots are collectively shared with other robots. In such a fashion, these robots may be configured to learn and/or share sensor data in order to facilitate the ability to readily detect and/or identify errors and/or assist events.

Still referring to FIG. 1A, operative units 104 may be coupled to controller 118, or any other controller, to perform the various operations described in this disclosure. One, more, or none of the modules in operative units 104 may be included in some embodiments. Throughout this disclosure, reference may be made to various controllers and/or processing devices. In some embodiments, a single controller (e.g., controller 118) may serve as the various controllers and/or processing devices described. In other embodiments different controllers and/or processing devices may be used, such as controllers and/or processing devices used particularly for one or more operative units 104. Controller 118 may send and/or receive signals, such as power signals, status signals, data signals, electrical signals, and/or any other desirable signals, including discrete and analog signals to operative units 104. Controller 118 may coordinate and/or manage operative units 104, and/or set timings (e.g., synchronously or asynchronously), turn off/on control power budgets, receive/send network instructions and/or updates, update firmware, send interrogatory signals, receive and/or send statuses, and/or perform any operations for running features of robot 102.

Returning to FIG. 1A, operative units 104 may include various units that perform functions for robot 102. For example, operative units 104 include at least navigation units 106, actuator units 108, user interface units 112, sensor units 114, and communication units 116. Operative units 104 may also comprise other units that provide the various functionality of robot 102. In exemplary embodiments, operative units 104 may be instantiated in software, hardware, or both software and hardware. For example, in some cases, units of operative units 104 may comprise computer-implemented instructions executed by a controller. In exemplary embodiments, units of operative unit 104 may comprise hardcoded logic. In exemplary embodiments, units of operative units 104 may comprise both computer-implemented instructions executed by a controller and hardcoded logic. Where operative units 104 are implemented in part in software, operative units 104 may include units/modules of code configured to provide one or more functionalities.

In exemplary embodiments, navigation units 106 may include systems and methods that may computationally construct and update a map of an environment, localize robot 102 (e.g., find the position) in a map, and navigate robot 102 to/from destinations. Wherein, one skilled in the art may appreciate that updating of the map of the environment may be performed in real-time while the robot 102 is traveling along the route. Alternatively, the map may be updated at a subsequent, later time when the robot 102 is stationary or no longer traveling along the route. The mapping may be performed by imposing data obtained in part by sensor units 114 into a computer-readable map representative at least in part of the environment. In exemplary embodiments, a map of an environment may be uploaded to robot 102 through user interface units 112, uploaded wirelessly or through wired connection, or taught to robot 102 by a user.

In exemplary embodiments, navigation units 106 may include components and/or software configured to provide directional instructions for robot 102 to navigate. Navigation units 106 may process maps, routes, and localization information generated by mapping and localization units, data from sensor units 114, and/or other operative units 104.

Still referring to FIG. 1A, actuator units 108 may include actuators such as electric motors, gas motors, driven magnet systems, solenoid/ratchet systems, piezoelectric systems (e.g., inchworm motors), magnetostrictive elements, gesticulation, and/or any way of driving an actuator known in the art. By way of illustration, such actuators may actuate the wheels for robot 102 to navigate a route; navigate around obstacles; rotate cameras and sensors. Actuator unit 108 may include any system used for actuating, in some cases to perform tasks. According to exemplary embodiments, actuator unit 108 may include systems that allow movement of robot 102, such as motorized propulsion. For example, motorized propulsion may move robot 102 in a forward or backward direction, and/or be used at least in part in turning robot 102 (e.g., left, right, and/or any other direction). By way of illustration, actuator unit 108 may control if robot 102 is moving or is stopped and/or allow robot 102 to navigate from one location to another location.

According to exemplary embodiments, sensor units 114 may comprise systems and/or methods that may detect characteristics within and/or around robot 102. Sensor units 114 may comprise a plurality and/or a combination of sensors. Sensor units 114 may include sensors that are internal to robot 102 or external, and/or have components that are partially internal and/or partially external. In some cases, sensor units 114 may include one or more exteroceptive sensors, such as sonars, light detection and ranging (“LiDAR”) sensors, radars, lasers, cameras (including video cameras, e.g., red-blue-green (“RBG”) cameras, infrared cameras, three-dimensional (“3D”) cameras, thermal cameras, etc.), time-of-flight (“ToF”) cameras, structured light cameras, antennas, motion detectors, microphones, and/or any other sensor known in the art). According to some exemplary embodiments, sensor units 114 may collect raw measurements (e.g., currents, voltages, resistances, gate logic, etc.) and/or transformed measurements (e.g., distances, angles, detected points in obstacles, etc.). In some cases, measurements may be aggregated and/or summarized. Sensor units 114 may generate data based at least in part on distance or height measurements. Such data may be stored in data structures, such as matrices, arrays, queues, lists, stacks, bags, etc.

According to exemplary embodiments, sensor units 114 may include sensors that may measure internal characteristics of robot 102. For example, sensor units 114 may measure temperature, power levels, statuses, and/or any characteristic of robot 102. In some cases, sensor units 114 may be configured to determine the odometry of robot 102. For example, sensor units 114 may include proprioceptive sensors, which may comprise sensors such as accelerometers, inertial measurement units (“IMU”), odometers, gyroscopes, speedometers, cameras (e.g. using visual odometry), clock/timer, and the like. Odometry may facilitate autonomous navigation and/or autonomous actions of robot 102. This odometry may include robot 102's position (e.g., where position may include robot's location, displacement and/or orientation, and may sometimes be interchangeable with the term pose as used herein) relative to the initial location. Such data may be stored in data structures, such as matrices, arrays, queues, lists, stacks, bags, etc. According to exemplary embodiments, the data structure of the sensor data may be called an image.

According to exemplary embodiments, sensor units 114 may be in part external to the robot 102 and coupled to communications units 116. For example, a security camera within an environment of a robot 102 may provide a controller 118 of the robot 102 with a video feed via wired or wireless communication channel(s). In some instances, sensor units 114 may include sensors configured to detect a presence of an object at a location such as, for example without limitation, a pressure or motion sensor may be disposed at a shopping cart storage location of a grocery store, wherein the controller 118 of the robot 102 may utilize data from the pressure or motion sensor to determine if the robot 102 should retrieve more shopping carts for customers.

According to exemplary embodiments, user interface units 112 may be configured to enable a user to interact with robot 102. For example, user interface units 112 may include touch panels, buttons, keypads/keyboards, ports (e.g., universal serial bus (“USB”), digital visual interface (“DVI”), Display Port, E-Sata, Firewire, PS/2, Serial, VGA, SCSI, audioport, high-definition multimedia interface (“HDMI”), personal computer memory card international association (“PCMCIA”) ports, memory card ports (e.g., secure digital (“SD”) and mini SD), and/or ports for computer-readable medium), mice, rollerballs, consoles, vibrators, audio transducers, and/or any interface for a user to input and/or receive data and/or commands, whether coupled wirelessly or through wires. Users may interact through voice commands or gestures. User interface units 218 may include a display, such as, without limitation, liquid crystal display (“LCDs”), light-emitting diode (“LED”) displays, LED LCD displays, in-plane-switching (“IPS”) displays, cathode ray tubes, plasma displays, high definition (“HD”) panels, 4K displays, retina displays, organic LED displays, touchscreens, surfaces, canvases, and/or any displays, televisions, monitors, panels, and/or devices known in the art for visual presentation. According to exemplary embodiments user interface units 112 may be positioned on the body of robot 102. According to exemplary embodiments, user interface units 112 may be positioned away from the body of robot 102 but may be communicatively coupled to robot 102 (e.g., via communication units including transmitters, receivers, and/or transceivers) directly or indirectly (e.g., through a network, server, and/or a cloud). According to exemplary embodiments, user interface units 112 may include one or more projections of images on a surface (e.g., the floor) proximally located to the robot, e.g., to provide information to the occupant or to people around the robot. The information could be the direction of future movement of the robot, such as an indication of moving forward, left, right, back, at an angle, and/or any other direction. In some cases, such information may utilize arrows, colors, symbols, etc.

According to exemplary embodiments, communications unit 116 may include one or more receivers, transmitters, and/or transceivers. Communications unit 116 may be configured to send/receive a transmission protocol, such as BLUETOOTH®, ZIGBEE®, Wi-Fi, induction wireless data transmission, radio frequencies, radio transmission, radio-frequency identification (“RFID”), near-field communication (“NFC”), infrared, network interfaces, cellular technologies such as 3G (3GPP/3GPP2), high-speed downlink packet access (“HSDPA”), high-speed uplink packet access (“HSUPA”), time division multiple access (“TDMA”), code division multiple access (“CDMA”) (e.g., IS-95A, wideband code division multiple access (“WCDMA”), etc.), frequency hopping spread spectrum (“FHSS”), direct sequence spread spectrum (“DSSS”), global system for mobile communication (“GSM”), Personal Area Network (“PAN”) (e.g., PAN/802.15), worldwide interoperability for microwave access (“WiMAX”), 802.20, long term evolution (“LTE”) (e.g., LTE/LTE-A), time division LTE (“TD-LTE”), global system for mobile communication (“GSM”), narrowband/frequency-division multiple access (“FDMA”), orthogonal frequency-division multiplexing (“OFDM”), analog cellular, cellular digital packet data (“CDPD”), satellite systems, millimeter wave or microwave systems, acoustic, infrared (e.g., infrared data association (“IrDA”)), and/or any other form of wireless data transmission.

Communications unit 116 may also be configured to send/receive signals utilizing a transmission protocol over wired connections, such as any cable that has a signal line and ground. For example, such cables may include Ethernet cables, coaxial cables, Universal Serial Bus (“USB”), FireWire, and/or any connection known in the art. Such protocols may be used by communications unit 116 to communicate to external systems, such as computers, smart phones, tablets, data capture systems, mobile telecommunications networks, clouds, servers, or the like. Communications unit 116 may be configured to send and receive signals comprised of numbers, letters, alphanumeric characters, and/or symbols. In some cases, signals may be encrypted, using algorithms such as 128-bit or 256-bit keys and/or other encryption algorithms complying with standards such as the Advanced Encryption Standard (“AES”), RSA, Data Encryption Standard (“DES”), Triple DES and the like. Communications unit 116 may be configured to send and receive statuses, commands, and other data/information. For example, communications unit 116 may communicate with a user operator to allow the user to control robot 102. Communications unit 116 may communicate with a server/network (e.g., a network) in order to allow robot 102 to send data, statuses, commands, and other communications to the server. The server may also be communicatively coupled to computer(s) and/or device(s) that may be used to monitor and/or control robot 102 remotely. Communications unit 116 may also receive updates (e.g., firmware or data updates), data, statuses, commands, and other communications from a server for robot 102.

In exemplary embodiments, operating system 110 may be configured to manage memory 120, controller 118, power supply 122, modules in operative units 104, and/or any software, hardware, and/or features of robot 102. For example, and without limitation, operating system 110 may include device drivers to manage hardware recourses for robot 102.

In exemplary embodiments, power supply 122 may include one or more batteries, including, without limitation, lithium, lithium ion, nickel-cadmium, nickel-metal hydride, nickel-hydrogen, carbon-zinc, silver-oxide, zinc-carbon, zinc-air, mercury oxide, alkaline, or any other type of battery known in the art. Certain batteries may be rechargeable, such as wirelessly (e.g., by resonant circuit and/or a resonant tank circuit) and/or plugging into an external power source. Power supply 122 may also be any supplier of energy, including wall sockets and electronic devices that convert solar, wind, water, nuclear, hydrogen, gasoline, natural gas, fossil fuels, mechanical energy, steam, and/or any power source into electricity.

One or more of the units described with respect to FIG. 1A (including memory 120, controller 118, sensor units 114, user interface unit 112, actuator unit 108, communications unit 116, mapping and localization unit 126, and/or other units) may be integrated onto robot 102, such as in an integrated system. However, according to some exemplary embodiments, one or more of these units may be part of an attachable module. This module may be attached to an existing apparatus to automate so that it behaves as a robot. Accordingly, the features described in this disclosure with reference to robot 102 may be instantiated in a module that may be attached to an existing apparatus and/or integrated onto robot 102 in an integrated system. Moreover, in some cases, a person having ordinary skill in the art would appreciate from the contents of this disclosure that at least a portion of the features described in this disclosure may also be run remotely, such as in a cloud, network, and/or server.

As used herein, a robot 102, a controller 118, or any other controller, processing device, or robot performing a task, operation or transformation illustrated in the figures below comprises a controller executing computer-readable instructions stored on a non-transitory computer-readable storage apparatus, such as memory 120, as would be appreciated by one skilled in the art.

Next referring to FIG. 1B, the architecture of a processor or processing device 138 is illustrated according to an exemplary embodiment. As illustrated in FIG. 1B, the processing device 138 includes a data bus 128, a receiver 126, a transmitter 134, at least one processor 130, and a memory 132. The receiver 126, the processor 130 and the transmitter 134 all communicate with each other via the data bus 128. The processor 130 is configurable to access the memory 132, which stores computer code or computer-readable instructions in order for the processor 130 to execute the specialized algorithms. As illustrated in FIG. 1B, memory 132 may comprise some, none, different, or all of the features of memory 120 previously illustrated in FIG. 1A. The algorithms executed by the processor 130 are discussed in further detail below. The receiver 126 as shown in FIG. 1B is configurable to receive input signals 124. The input signals 124 may comprise signals from a plurality of operative units 104 illustrated in FIG. 1A including, but not limited to, sensor data from sensor units 114, user inputs, motor feedback, external communication signals (e.g., from a remote server), and/or any other signal from an operative unit 104 requiring further processing. The receiver 126 communicates these received signals to the processor 130 via the data bus 128. As one skilled in the art would appreciate, the data bus 128 is the means of communication between the different components—receiver, processor, and transmitter—in the processing device. The processor 130 executes the algorithms, as discussed below, by accessing specialized computer-readable instructions from the memory 132. Further detailed description as to the processor 130 executing the specialized algorithms in receiving, processing and transmitting of these signals is discussed above with respect to FIG. 1A. The memory 132 is a storage medium for storing computer code or instructions. The storage medium may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage medium may include volatile, nonvolatile, dynamic, static, read/write, read-only, random-access, sequential-access, location-addressable, file-addressable, and/or content-addressable devices. The processor 130 may communicate output signals to transmitter 134 via data bus 128 as illustrated. The transmitter 134 may be configurable to further communicate the output signals to a plurality of operative units 104 illustrated by signal output 136.

One of ordinary skill in the art would appreciate that the architecture illustrated in FIG. 1B may illustrate an external server architecture configurable to effectuate the control of a robotic apparatus from a remote location. That is, the server may also include a data bus, a receiver, a transmitter, a processor, and a memory that stores specialized computer-readable instructions thereon.

One of ordinary skill in the art would appreciate that a controller 118 of a robot 102 may include one or more processing devices 138 and may further include other peripheral devices used for processing information, such as ASICS, DPS, proportional-integral-derivative (“PID”) controllers, hardware accelerators (e.g., encryption/decryption hardware), and/or other peripherals (e.g., analog to digital converters) described above in FIG. 1A. The other peripheral devices when instantiated in hardware are commonly used within the art to accelerate specific tasks (e.g., multiplication, encryption, etc.) which may alternatively be performed using the system architecture of FIG. 1B. In some instances, peripheral devices are used as a means for intercommunication between the controller 118 and operative units 104 (e.g., digital to analog converters and/or amplifiers for producing actuator signals). Accordingly, as used herein, the controller 118 executing computer-readable instructions to perform a function may include one or more processing devices 138 thereof executing computer-readable instructions and, in some instances, the use of any hardware peripherals known within the art. Controller 118 may be illustrative of various processing devices 138 and peripherals integrated into a single circuit die or distributed to various locations of the robot 102 which receive, process, and output information to/from operative units 104 of the robot 102 to effectuate control of the robot 102 in accordance with instructions stored in a memory 120, 132. For example, controller 118 may include a plurality of processing devices 138 for performing high-level tasks (e.g., planning a route to avoid obstacles) and processing devices 138 for performing low-level tasks (e.g., producing actuator signals in accordance with the route).

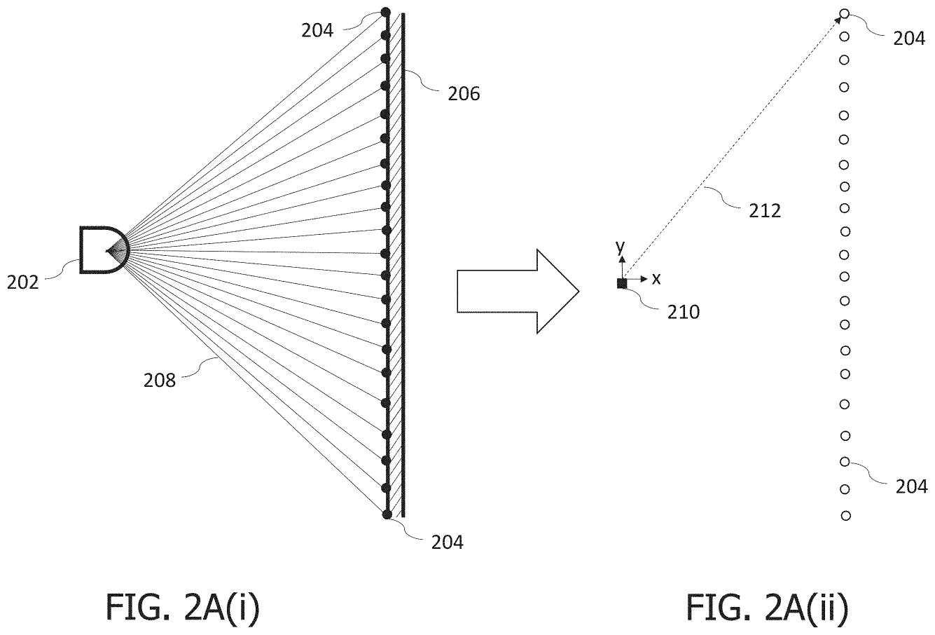

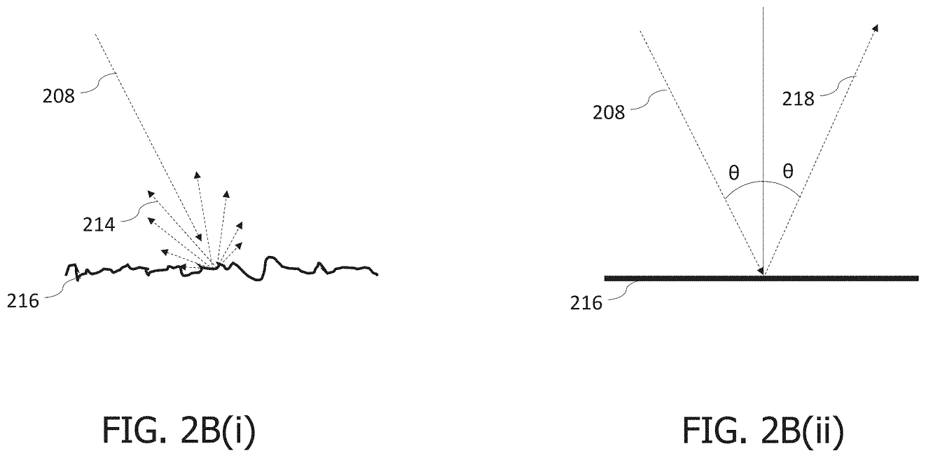

FIG. 2A(i-ii) illustrates a planar light detection and ranging (“LiDAR”) or a time-of-flight (“ToF”) sensor 202 coupled to a robot 102, which collects distance measurements to a wall 206 along a measurement plane in accordance with some exemplary embodiments of the present disclosure. Sensor 202, illustrated in FIG. 2A(i), may be configured to collect distance measurements to the wall 206 by projecting a plurality of beams 208 of photons at discrete angles along a measurement plane and determining the distance to the wall 206 based on a time-of-flight of the photons leaving the sensor 202, reflecting off the wall 206, and returning back to the sensor 202. The measurement plane of the sensor 202 comprises a plane along which the beams 208 are emitted which, for this exemplary embodiment illustrated, is the plane of the page.

Individual beams 208 of photons may localize respective points 204 of the wall 206 in a point cloud, the point cloud comprising a plurality of points 204 localized in 2D or 3D space as illustrated in FIG. 2A(ii). The points 204 may be defined about a local origin 210 of the sensor 202. Distance 212 to a point 204 may comprise half the time-of-flight of a photon of a respective beam 208 used to measure the point 204 multiplied by the speed of light, wherein coordinate values (x, y) of each respective point 204 depends both on distance 212 and an angle at which the respective beam 208 was emitted from the sensor 202. The local origin 210 may comprise a predefined point of the sensor 202 to which all distance measurements are referenced (e.g., location of a detector within the sensor 202, focal point of a lens of sensor 202, etc.). For example, a 5-meter distance measurement to an object corresponds to 5 meters from the local origin 210 to the object.

According to at least one non-limiting exemplary embodiment, sensor 202 may be illustrative of a depth camera or other ToF sensor configurable to measure distance, wherein the sensor 202 being a planar LiDAR sensor is not intended to be limiting. Depth cameras may operate similar to planar LiDAR sensors (i.e., measure distance based on a ToF of beams 208); however, depth cameras may emit beams 208 using a single pulse or flash of electromagnetic energy, rather than sweeping a laser beam across a field of view. Depth cameras may additionally comprise a two-dimensional field of view.

According to at least one non-limiting exemplary embodiment, sensor 202 may be illustrative of a structured light LiDAR sensor configurable to sense distance and shape of an object by projecting a structured pattern onto the object and observing deformations of the pattern. For example, the size of the projected pattern may represent distance to the object and distortions in the pattern may provide information of the shape of the surface of the object. Structured light sensors may emit beams 208 along a plane as illustrated or in a preterminal pattern (e.g., a circle or series of separated parallel lines).

One skilled in the art would appreciate that a plurality of ToF sensors 202, such as planar LiDAR sensors, of sensor units 114 may be coupled to a robot 102 to enhance the navigation and localization capabilities of the robot 102. These ToF sensors 202 may be mounted in static positions (e.g., using screws, bolts, etc.) or may be mounted with servomotors configured to adjust the pose of the sensor 202. Glass objects and specular surfaces pose a unique problem for ToF sensors 202 as glass and specular surfaces behave differently from solid and opaque surfaces when beams 208 are incident upon the glass surfaces, as illustrated in FIG. 3A-B below. Time-of-flight, as used herein, may refer to a time-of-flight of light and exclude other time-of-flight sensors, such as sonars or ultrasonic sensors as these sensors may detect glass and specular objects without issue because they are not influenced by high optical transmissivity of glass nor optical specular reflection of specular objects. Accordingly, ToF sensors as used herein may include LiDAR sensors.

FIG. 2B(i-ii) illustrates two forms of reflections, diffuse reflections and specular reflections, in accordance with some embodiments of this disclosure. First, in FIG. 2B(i), diffuse reflection of a beam 208 incident upon a surface 216 is illustrated. The surface 216 may comprise, on a micrometer to nanometer scale, jagged edges, grooves, or other imperfections that cause the beam 208 to scatter, reflect, and bounce off the surface in a plurality of directions, as shown by reflected beams 214. One or more beams 214 may return to a sensor that emitted beam 208, such as the ToF sensor 202 depicted in FIG. 2A(i) above, such that the surface 216 may be localized by a point 204. However, a substantial majority of the incident power of beam 208 is not received at the detector of the sensor. One skilled in the art may appreciate that a scattered beam 214 is only detected by a ToF sensor 202 when it returns to the sensor along approximately the path traveled by incident beam 208.

Next, FIG. 2B(ii) illustrates specular reflection of a beam 208 incident upon a specular surface 216. Specular surfaces 216 may comprise highly reflective and/or substantially smooth surfaces. Specular reflection causes beam 208, incident upon surface at angle θ, to be reflected at an angle equal to the incident angle θ, angle θ defined with respect to a normal of surface 216, as illustrated by reflected beam 218 reflecting from surface 216 at an angle θ. A substantial majority of the power of the beam 208 is reflected and carried by beam 218. This poses a challenge for ToF sensors as beams 208 incident upon specular surfaces may reflect away from the sensor and not be in part returned and detected by the sensor, unlike diffuse reflection wherein a small portion of the incident beam 208 is reflected to the sensor. One skilled in the art may appreciate that a reflected beam 218 is only detected by a ToF sensor 202 when beam 208 is normally incident upon the specular surface 216 (i.e., θ=0°). This property of specular surfaces (e.g., mirrors), and similar properties of glass illustrated in FIG. 3, will be utilized to detect both glass and specular surfaces within an environment of a robot 102.

FIG. 3A-B illustrates transmission behavior of beams 208 when incident upon glass 302, according to an exemplary embodiment. Glass 302 may represent a window, pane, or any other form of glass, wherein glass may be comprised of fused quartz, fused-silica glass, soda-lime-silica glass, sodium borosilicate glass, Pyrex®, or any other substantially transparent solid material. Glass, as used herein, may comprise any of the aforementioned materials, exhibit primarily specular reflection, and be substantially transparent to a wavelength of light of a ToF sensor 202 (i.e., comprise a small reflection coefficient of 20%, 10%, 5%, etc. or transmissivity of at least 20% or higher). Beams 208 illustrated may represent paths followed by beams 208 emitted from a ToF sensor 202, as illustrated in FIG. 2A(i) above, incident upon the glass 302 at different angles that are enumerated differently for clarity. First, in FIG. 3A, a beam 208-I is incident on a glass 302 surface at normal incidence, or orthogonal to the surface of glass 302. Glass 302, in most instances, is not completely transparent (e.g., 90% transparent), thereby causing a portion of beam 208-I to be reflected as beam 208-R back towards a detector of the ToF sensor 202, the reflection being primarily due to specular reflection. The reflected beam 208-R may comprise approximately, e.g., 10% of the power of the incident beam 208-I and may typically be detected by the ToF sensor 202 at normal incidence. However, one skilled in the art may appreciate the reflected power detected by the sensor 202 further depends on the glass 302 properties and distance to the glass 302. Beam 208-T comprises the remaining (e.g., 90%) portion of the energy of the incident beam 208-I which is a transmitted beam through glass 302 and travels away from the sensor 202 and is not captured by the sensor 202. This beam 208-T may later reflect off a surface beyond the glass or may never return to the sensor 202.

Next, in FIG. 3B, beam 208-I, illustrative of a beam 208 emitted from a ToF sensor 202, is incident upon glass 302 at a glancing or grazing angle (i.e., any angle other than normal incidence but less than a critical angle). Due to glass 302 being substantially transparent, the beam 208-I may be substantially transmitted into and through the glass, wherein beam 208-T is approximately of the same power as beam 208-I. In some instances, beam 208-I may be incident upon glass 302 at an angle greater than a critical angle, wherein beam 208-I may exhibit specular reflection as illustrated by beam 208-R. This specular reflection, as illustrated by beam 208-R (dashed line indicating reflection does not always occur) may be reflected at a substantially large angle such that the sensor 202 may not receive the reflected beam 208-R and therefore, the sensor 202 does not record a distance measurement 212 or point 204.

It is appreciated by one skilled in the art that diffuse reflection from the surface of the glass 302 may still occur (e.g., due to small imperfections in the surface or ‘flatness’ of the glass 302), thereby causing a portion of beam 208-I emitted at a glancing angle to be reflected back to the ToF sensor 202. However, this reflected portion may be of significantly lower power than a threshold detection power or signal to noise (“SNR”) ratio of the sensor 202 required for detection, thereby significantly reducing a chance of localizing a point 204 of the glass 302 using a beam incident upon the glass at any angle other than normal incidence. One skilled in the art may appreciate that a beam 208-I incident on glass 302 at any angle other than normal incidence is either substantially transmitted through the glass 302 or reflected away from the ToF sensor 202, thereby causing the ToF sensor 202 to fail to detect the glass 302 surface.

As illustrated in FIGS. 3A-B, only beams 208, which are incident upon glass 302 at a substantially normal angle, are reflected back to a ToF sensor 202, as discussed above with respect to FIG. 3A. Accordingly, the ToF sensor 202 may only generate distance measurements 212 and points 204 at locations where beams 208 are normally incident on the glass 302. It is appreciated that some beams 208 incident upon glass 302 substantially close to normal incidence may also be detected by the detector of ToF sensor 202 (e.g., due to diffuse reflection if the surface of the glass 302 is not perfectly flat). One skilled in the art may appreciate that substantially reflective and opaque objects, such as polished surfaces, sheet metal walls, mirrors, and the like, may also exhibit a substantially similar behavior when being localized by beams 208 from a ToF sensor 202, wherein only beams 208 normally incident upon the reflective surface may be reflected back to a detector of the sensor 202 and the remaining beams 208 being reflected from the surface of the reflective objects and away from a detector of the sensor 202 as shown in FIG. 2B(ii). Accordingly, the systems and methods disclosed herein may also be utilized for detection of substantially reflective surfaces. Both glass and reflective surfaces or objects may cause inaccurate localization of the surfaces or objects due to the behavior of beams 208 when incident upon these objects, thereby potentially causing a robot 102 to misperceive a location of the objects that may cause collisions.

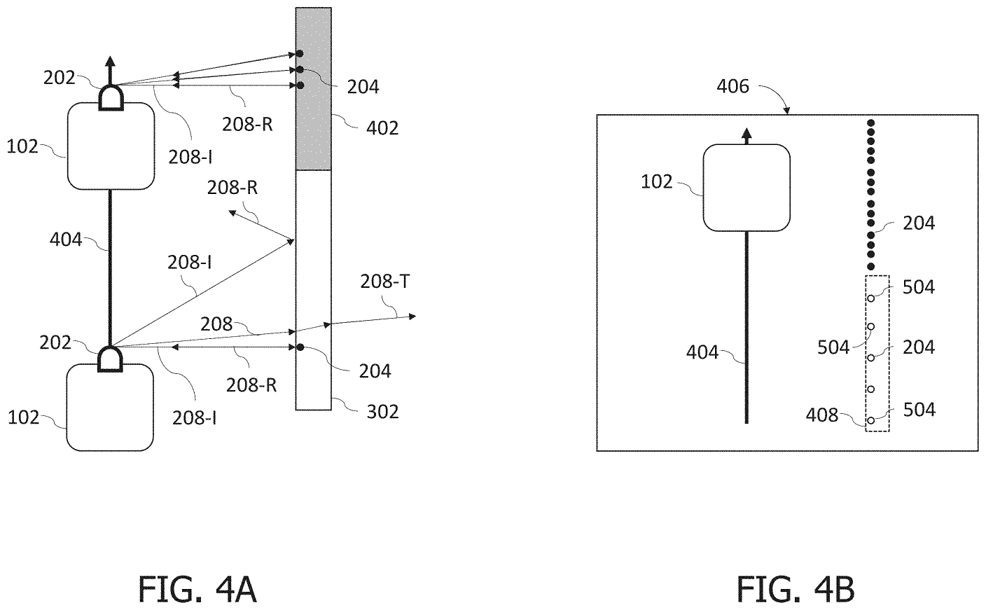

FIGS. 4A-B illustrates a robot 102 navigating a route 404 (FIG. 4A), wherein a controller 118 of the robot 102 generates a computer-readable map 406 (FIG. 4B) of an environment based on measurements 208 and points 204 localized by a ToF sensor 202, according to an exemplary embodiment. First, in FIG. 4A, the robot 102 navigates route 404 and utilizes ToF sensor 202 to collect distance measurements to nearby objects, such as glass 302 and wall 402, made of solid opaque material (e.g., concrete, plaster, etc.), and excludes glass or specular surfaces. Wall 402 exhibits diffuse reflection. It is appreciated that memory 120 of robot 102 does not comprise prior localization data for glass 302 and wall 402 nor prior indication that the glass 302 is a glass surface or object. As illustrated in FIGS. 3A-B, only beams 208, which are incident at substantially normal angle to the glass 302, are reflected back to a detector of the ToF sensor 202 and produce a localized point 204 on the computer-readable map 406.

FIG. 4A illustrates the robot 102 at two locations along the route 404 and a plurality of beams 208-I emitted by the sensor 202 at the two locations, wherein beams 208-R and beams 208-T illustrate the reflected and/or transmitted portion of the emitted beams 208-I respectively. At the first location (bottom of the page), the robot 102 utilizes the ToF sensor 202 to localize the glass 302, wherein only one beam 208 is reflected back to the sensor 202 and the remaining beams 208 are either transmitted through the glass 302, exhibit specular reflection off the glass 302 (if incident at an angle equal to or greater than the critical angle), or do not reflect off any objects. Only three beams 208 are illustrated while the robot 102 is at the first location for clarity. However, it is appreciated that additional beams 208 may be emitted from the ToF sensor 202 at additional angles. Later, the robot 102 may continue along the route 404 and reach the second illustrated location (top of the page) to collect another scan or measurement using the ToF sensor 202 of the opaque wall 402. Beams 208 incident upon the wall 402 may be reflected diffusely back to the detector of the sensor 202 to localize points 204 representing the wall 402. Accordingly, only a few points 204, measured by beams 208 incident upon the glass 302 at normal incidence, which represent glass 302 are detected by the ToF sensor 202 and are recorded on the map 406 whereas substantially more points 204 localize the opaque wall 402, as illustrated in FIG. 4B.

FIG. 4B illustrates a computer-readable map 406 generated by the controller 118 of the robot 102 previously illustrated in FIG. 4A using a plurality of scans from the ToF sensor 202 as the robot 102 navigates route 404. The computer-readable map 406 is based on distance measurements from the ToF sensor 202. As illustrated, the computer-readable map 406 comprises a plurality of points 204 that localize the glass 302 and wall 402. Due to the specular and transparent nature of glass 302, illustrated in FIG. 3A-B above, some of the beams 208 from sensor 202 are not reflected back to the detector and/or are below threshold detection strength. Only points 204 sampled when the beams 208 from sensor 202 are normal to the glass 302 will be detected and localized by the sensor 202. These points are spatially separated by a distance equal to a sample rate of the sensor 202 (i.e., scan or pulse period) and the speed of the robot 102 along route 404 parallel to the surface of glass 302. In contrast, ToF sensors will detect more points from the opaque wall 402, because more beams 208 will be diffusely reflected back to sensor 202. As a result, the points 204 within region 408 (representative of area occupied by glass 302 outlined for clarity) are more separated or are of lower density relative to points 204 which localize opaque wall 402 (i.e., points outside region 408). That is, the controller 118 of the robot 102 is able to differentiate between the wall 402 and the glass 302 based on the difference in spatial separation or density of localized points 204 as shown on the computer-readable map 406.

One skilled in the art may appreciate that if route 404 is not parallel to the surface of glass 302, the separation between points 204 representing glass 302 may further depend on a cosine of an angle of the route 404 with respect to the surface of the glass 302. A controller 118 of the robot 102 may detect the spatial separation of points 204 within the region 408 to be larger than points 204 beyond region 408 and identify these points as “suspicious points” 504, comprising points of the map 406 which could potentially be glass or a specular surface (e.g., a mirror) to be verified using methods illustrated below. Stated differently, the points 504 are identified by the controller 118 as “suspicious points” because of the distance between two adjacent points 204 being greater than two adjacent points 204 detected in relationship to an opaque wall or surface.

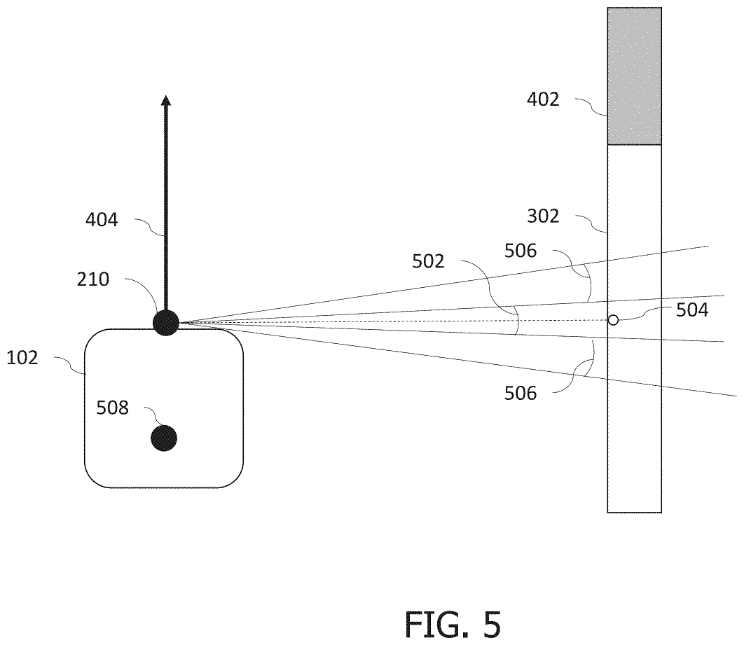

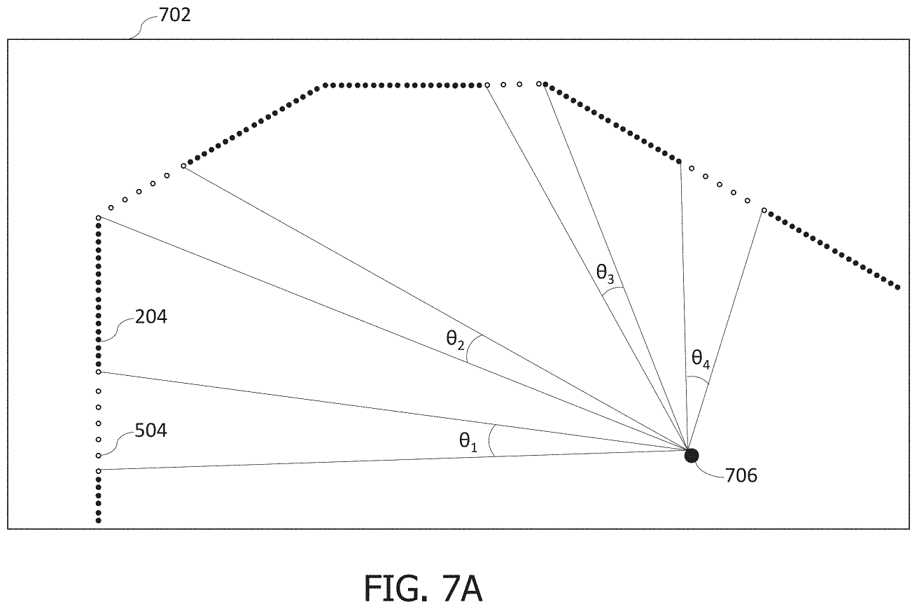

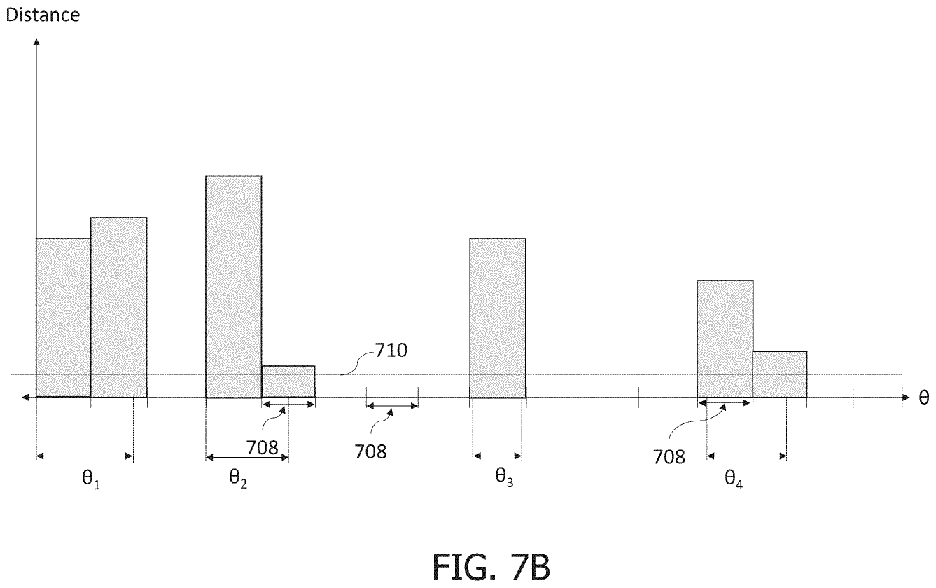

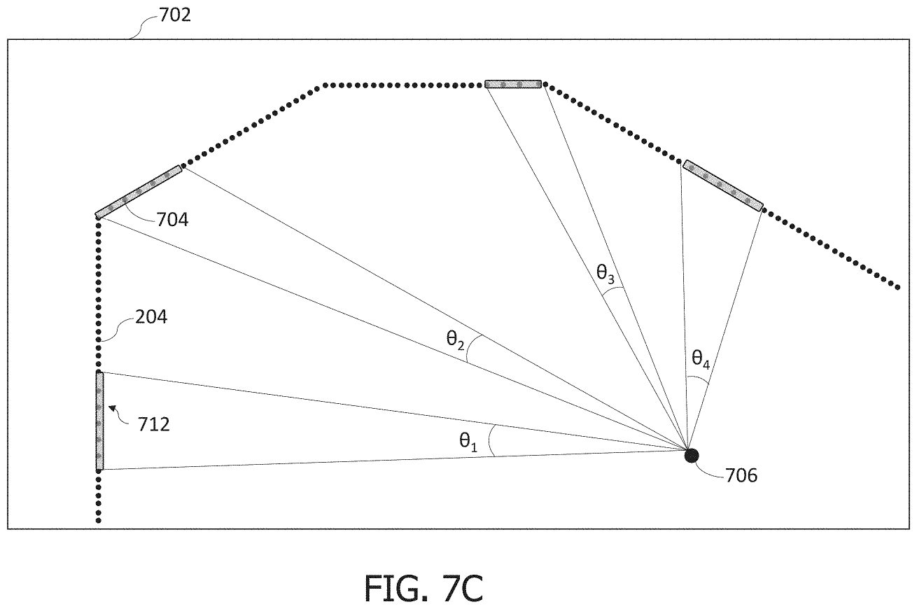

FIG. 5 is a closer view of the robot 102 depicted in FIG. 4A above to further illustrate a suspicious point 504 and a method for detecting the suspicious point 504, according to an exemplary embodiment. Robot 102 may localize itself during every scan or pulse of light emitted from a ToF sensor 202, illustrated in FIG. 4 above, wherein the robot 102 may localize a local origin 508 with respect to a world frame origin 706, illustrated below in FIGS. 7A and 7C. The origin 508 may comprise a fixed point on the robot 102 (with respect to the frame of reference of the robot 102) where the position of the robot 102 is defined (i.e., the robot 102 being at position (x, y) corresponds to origin 508 being at position (x, y)). The origin 706 of a world frame may comprise a fixed point in the environment of the robot 102 (e.g., a landmark or home base) from which the robot 102 localizes its origin 508. The relation between origin 210 and origin 508 comprises a fixed transform or spatial separation which is stored in memory 120. Accordingly, by localizing the origin 508 within the environment, the controller 118 is always able to localize the local sensor origin 210 during autonomous navigation (e.g., during each scan or measurement from the sensor 202).

A scan from the ToF sensor 202, as used herein, may comprise a single sweep of a laser beam across a field of view of the sensor 202 for a planar or scanning LiDAR sensor, a single pulse, flash, or emission of electromagnetic energy (i.e., a depth image) from a depth camera sensor, or emission or sampling of a structured light pattern. The robot origin 508 may comprise any predetermined point of the robot 102 (e.g., a center point of a wheel axle) which denotes a current location of the robot 102 in its environment. A pose, or (x, y, z, yaw, pitch, roll) position, of sensor 202 with respect to robot origin 504 may be a predetermined value specified, for example, by a manufacturer of the robot 102 with respect to this origin 508. Accordingly, sensor origin 210 may be localized by the controller 118, using navigation units 106, during every scan of the sensor 202 with respect to robot origin 508 using a fixed transform (assuming no calibration is required), which is further localized with respect to a world origin 706 using a transform based on a location of the robot 102.

To determine if a point 204 generated by a scan or pulse of sensor 202 produces a suspicious point 504, or a point that is potentially indicative of a glass surface or specular object, angular thresholds 502, 506 are imposed. Controller 118 of the robot 102 may execute computer-readable instructions to impose these thresholds 502, 506 on a computer-readable map (e.g., 406) generated, at least in part, using point cloud data from sensor 202. Threshold 502 may comprise an allowance threshold to allow for more than one point 204 generated by a scan of sensor 202 to still potentially indicate glass (e.g., due to noise). It is appreciated by one skilled in the art that the depiction of specular reflection from glass 302 depicted in FIG. 3 above is an ideal scenario, wherein more than one point 204 may be localized by sensor 202 when sensing glass 302 due to, for example, imperfections in the glass surface, noise in the sensor 202, imperfect localization of origin 506, and other natural phenomena familiar to one skilled in the art. If the glass was perfectly flat, the sensor 202 comprises no noise, and the controller 118 may perfectly localize the robot origin 508 and sensor origin 210, then allowance threshold 502 is not necessary, wherein allowance threshold 502 may be tuned based on the noise level of sensor 202, localization capabilities of controller 118, and typical flatness of glass 302 surfaces.

Next, thresholds 506 comprise suspicion thresholds wherein, for any single scan, lack of detection or localization of any point 204 within the suspicion thresholds 506 may correspond to any one or more points 204 within allowance threshold 502 to potentially indicate detection of glass. That is, allowance threshold 502 lies within or between suspicion thresholds 506 to account for noise and other imperfections. The angular size of allowance threshold 502 may depend on noise of the sensor 202, typical imperfections in glass surfaces, and localization capabilities of controller 118. The angular size of the suspicion thresholds 506 may be based on a speed of robot 102, sampling or scanning rate of the sensor 202, and distance between robot 102 and a surface formed by glass 302 and wall 402. The controller 118 may, for each point 204 of a scan from a sensor 202, center the allowance threshold 502 about each point 204 (shown by a dashed line between origin 210 and the localized point) and determine if each/every point 204 within the allowance threshold 502 are suspicious points 504 based on a lack of detection of any points 204 within suspicion threshold 506. The combined angle formed by the two suspicion thresholds 506 and allowance threshold 502 is more than twice the angular resolution of the sensor 202 such that the combined angle comprises a field of view about the sensor origin 210 which includes at least (i) the beam 208 used to produce the point, and (ii) at least two adjacent beams 208.

According to at least one non-limiting exemplary embodiment, controller 118 may, for any single scan or pulse by ToF sensor 202, sweep the angles across an entire field of view of the sensor 202 about the sensor origin 210. The sweeping may be performed to ensure that the orientation of the robot 102 is not limited to the illustrated example. If, during the sweep, points 204 are localized within allowance threshold 502 and no points are detected within suspicion thresholds 506, then all points 204 within the allowance threshold 502 are identified by controller 118 to comprise suspicious points 504. In some embodiments, the controller 118 positions thresholds 502, 506 about each localized point 204 and determines if each of the points 204 are suspicious points 504 based on a lack of detecting other points 204 within thresholds 506.

According to at least one non-limiting exemplary embodiment, a threshold number of suspicious points 504 may be required to be detected prior to the suspicious points 504 being denoted as suspicious points. For example, detection of one point 204 within threshold 502 and no points within threshold 506 may not be sufficient to indicate a glass surface or suspicious point 504 if no other nearby points 204 meet these thresholds 502, 506 criterion. For example, this may correspond to the sensor detecting a thin object such as a wire.

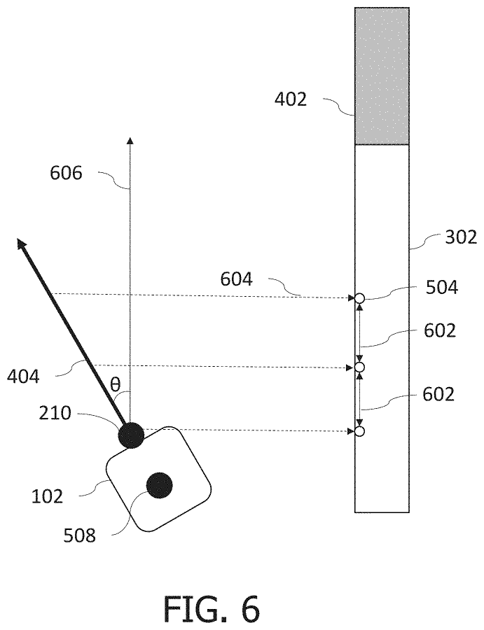

FIG. 6 illustrates another method for identifying suspicious points 504 using a distance threshold 602, according to an exemplary embodiment. The method used to determine suspicious points 504 illustrated in FIG. 6 may be advantageous in reducing computational complexity of identifying suspicious points 504 at a cost of accuracy of localizing and detecting glass 302. To identify suspicious points 504, a distance threshold 602 may be utilized. Distance threshold 602 comprises a distance equal to the sampling period (i.e., pulse period or one over the scan time) of the ToF sensor 202 multiplied by the velocity of the robot 102 along path 404 and the cosine of angle θ (i.e., distance of threshold 602 d_{threshold 602}=Tₛₐₘₚₗₑ v_{robot} cos(θ)). Angle θ is defined as the angular difference between the path 404 of the robot 102 and the line formed by consecutive suspicious points 504, as illustrated by axis 606, which is substantially parallel to the surface of the glass 302. As illustrated in FIGS. 3A-B above, only beams 208 incident upon glass 302 at substantially normal incidence are detected (i.e., reflected back to sensor 202) and localized as points 204 on a computer-readable map or point cloud whereas the remaining beams 208 are either reflected away from the surface 302 and/or transmitted through surface 302 (if surface 302 is glass). This is illustrated by lines 604, which denote the paths followed by three beams 208 emitted during three sequential scans as the robot 102 moves along the route 404; the three beams 208 are normally incident upon the glass 302 surface. The remaining beams 208 emitted during the three scans travel different paths and are either reflected away from or transmitted through the glass 302 and do not reach the sensor 202 such that no points 204 are localized.

According to at least one non-limiting exemplary embodiment, the angle θ may require at least two suspicious points 504 to be identified prior to axis 606 being defined with respect to robot 102. Accordingly, when one or no suspicious points 504 are detected, threshold 602 may instead comprise a predetermined value with no angular dependence on θ, the value being less than the speed of the robot 102 multiplied by the sampling rate of the sensor (i.e., with no angular dependence since θ is not yet defined). In some instances, the predetermined value may be based on the measured distance and angular resolution of the sensor 202. In this embodiment, the at least two suspicious points 504 required to define the axis 606 may be identified based on two points 204, localized by two sequential scans from the sensor, being spatially separated by the threshold value. Upon defining axis 606, the two points 204 may or may not fall within the threshold 602 once angular dependence on θ is included and the threshold calculation utilizes the speed of the robot 102. That is, in instances where initially no suspicious points 504 are detected, controller 118 may relax or shrink the size of thresholds 602 to generate at least two suspicious points 504 and, upon detecting two or more suspicious points 504 to define axis 606, the controller 118 may revisit these suspicious points 504 and compare them with the threshold 602 which includes the angular dependence on θ and the real speed of the robot 102.

According to at least one non-limiting exemplary embodiment, angular thresholds 502, 506 illustrated in FIG. 5 above may be utilized to identify the first at least two suspicious points 504 used to define axis 606. In some embodiments, axis 606 may be parallel to a best fit line, which comprises a linear approximation of a line formed by suspicious points 504.

One skilled in the art may appreciate that detection of suspicious points 504 from a plurality of points 204 may be performed after the robot 102 has completed its route. For example, a robot 102 may be shown, pushed along, or driven along a route 404 during a training process. During navigation of the route 404, the robot 102 may collect a plurality of scans from at least the ToF sensor 202 to generate a computer-readable map of its environment. This computer-readable map may be utilized to retrospectively detect suspicious points 504 based on the location of the origin 210 of the ToF sensor 202 during navigation along the route and thresholds 502, 504 or 602. Advantageously, retrospectively detecting suspicious points 504 may reduce a computational load imposed on the controller 118 during navigation of the route 404 (e.g., during training).

Advantageously, the method illustrated in FIG. 6 may reduce computational complexity of identifying suspicious points 504 by: (i) removing a requirement for localizing a robot origin 508 and sensor origin 210 for every scan; and (ii) removing the calculation of angular thresholds 502, 506 on a computer-readable map for point 204 of each scan which may take substantially more time. On the other hand, the method illustrated in FIG. 6 may be, (i) susceptible to error as one point 204 may be detected between two other points 204 on a glass 302 object due to, e.g., random noise, wherein the one point 204 may cause the two points 204 and the one point 204 to not be identified as suspicious points; and (ii) may be susceptible to false identification of one or more points 204 as suspicious points 502 as other factors may cause spatial separation between two adjacent points 504 to be equal to the threshold 602, such as if points 204 are localized substantially far away from robot 102. One skilled in the art may appreciate these costs and benefits may be tuned based on specifications of a robot 102 such as, for example, computing resources of a controller 118, noise level and precision of sensor units 114, and a plurality of other common considerations within the art.

FIG. 7A-C illustrates a controller 118 utilizing a computer-readable map 702 to reassign suspicious points 504 to glass points 704, the glass points 704 being shown in FIG. 7C, according to an exemplary embodiment. Glass points 704 comprise points localized on the computer-readable map 702 based on measurements from a sensor 202, which are determined to detect a glass objects/surfaces. It is appreciated that the present disclosure is not limited to detection of glass as specular surfaces, such as mirrors, may exhibit substantially similar properties as glass as shown in FIG. 2-3 above. Accordingly, the methods discussed in the exemplary embodiment of FIG. 7A-C for detecting glass points 704 may be equally applicable for detecting points 204 which localize specular surfaces, wherein use of “glass” points 704 is intended to be illustrative and non-limiting.

First, in FIG. 7A, a robot 102 may have navigated around its environment and scanned a wall comprising, in part, glass panes or windows to produce the computer-readable map 702 based on point cloud scans from the sensor 202. The points 204 of the map 702 illustrated are localized by the sensor 202, wherein other sensors 202 of the robot 102 may produce other point cloud representations of the environment similar to map 702. World origin 706 is a predetermined fixed point within the environment of the robot 102 from which localization of robot origin 508, and thereby origin 210 of the sensor 202, is defined. The world origin 706 may comprise, for example, a home base (e.g., a marker), a start of a route, or a landmark. The robot 102 may be located anywhere on the map 702 or may be idle external to the environment depicted by the map 702.

Some points 204 are identified as suspicious points 504 (empty circles) using methods illustrated in FIG. 5-6 above, wherein the suspicious points 504 may possibly or potentially indicate or detect glass to be verified using a method discussed below. To confirm these suspicious points 504 are points 704 that localize glass, a controller 118 may create a plurality of angular bins. Angular bins are further illustrated in FIG. 7B graphically, wherein each angular bin comprises an arc length of a 360° circle about the world origin 706. That is, each angular bin comprises a discretized angular region or portion of the 360° circle about the world origin 706, wherein each angular bin may comprise 1°, 5°, 15°, etc. arc lengths.

Angles θ₁, θ₂, θ₃, and θ₄ represent arbitrary angular ranges wherein adjacent suspicious points 504 are detected in sequence or in an approximately straight line. In some embodiments, each suspicious point 504 and adjacent suspicious points 504 are identified as a ‘potential glass’ objects on a computer-readable map, wherein the angles θ₁-θ₄ represent angular sizes of these potential glass objects formed by suspicious points 504 with respect to world origin 706. Each angular bin may be populated with a value based on a summation of distances from the world origin 706 to all suspicious points 504 encompassed within the respective angular bin.

FIG. 7B illustrates the angular bins 708 used for glass detection in a graphical format, according to an exemplary embodiment. The horizontal axis of the graph may comprise an angle θ about a world origin 706, illustrated in FIG. 7A above. The vertical axis may comprise a sum of distance measurements between the world origin 706 and each suspicious point 504 encompassed within a respective angular bin. As illustrated, the horizontal axis is divided into a plurality of bins 708, each comprising a discrete angular range (e.g., 1°, 5°, 10°, etc.). For example, as illustrated in FIG. 7A, angular range θ₁ encompasses some suspicious points 504, wherein the angular range may be discretized into two bins 708 as shown in FIG. 7B. Angular ranges θₙ may encompass one or more bins 708, wherein some of the angular ranges θₙ starting and/or stopping at the edges of the bins 708 is not intended to be limiting. That is, angular ranges θₙ are illustrated for visual reference between FIG. 7A-B to illustrate the angular range occupied by suspicious points 504 on map 702 and are not intended to denote the angular ranges of bins 708.

Distances to each suspicious point within the range θ₁ may be summed and plotted onto the graph illustrated in FIG. 7B, wherein the angular bins encompassed by θ₁ as illustrated in FIG. 7B comprise a sum of distances greater than a threshold 710. Threshold 710 may comprise a static (e.g., fixed value) or dynamic threshold (e.g., based on a mean value of distances within each or all bins 708), wherein any angular bin 708 comprising a sum of distances from the world origin 706 to suspicious points 504 encompassed therein which exceeds the threshold 710 may correspond to the suspicious points 504 encompassed therein being indicative of glass. Threshold 710 may be implemented to remove suspicious points 504 which do not localize glass objects. For example, some scans by sensor 202 may cause detection of one or very few suspicious points 504 for a plurality of reasons (e.g., noise in the sensor 202, thin objects, spatially separate objects, etc.). Threshold 710, however, will not be exceeded unless multiple consecutive and adjacent scans generate multiple adjacent suspicious points 504, thereby removing suspicious points 504, which do not localize glass from the later identified glass points 704. By way of illustrative example, some angular bins 708 of the graph illustrated comprise zero distance, corresponding to no or very few suspicious points 504 detected within the respective angular bin 708 whereas other angular bins 708 may include a plurality of suspicious points 504 and may therefore comprise a larger cumulative distance value.

According to at least one non-limiting exemplary embodiment, the summation of distances within each angular bin 708 may be normalized with respect to a value. The value may include, but is not limited to, a summation of all distance between the world origin 706 and all suspicious points; summation of all distances between the world origin 706 and all points 204, 504; an average value of distances within a respective angular bin; an average of the summations of distances for all angular bins; or a constant.

It is appreciated that the sizes or angular ranges of each angular bin 708 illustrated may be exaggerated for clarity. The exact angular range of each angular bin 708 may be smaller than as illustrated for improved localization and resolution of the objects, determined to comprise glass based on threshold 710, at a cost of increased computational complexity or workload imposed on controller 118.

FIG. 7C illustrates a plurality of glass objects 712 (shaded rectangles) on a computer-readable map 702, according to an exemplary embodiment. As illustrated above in FIG. 7B, angular bins 708 encompassed by respective angles θ₁, θ₂, θ₃, and θ₄ comprise distance summations exceeding a threshold value 710. Accordingly, all suspicious points 504 (illustrated in FIG. 7A) encompassed within the respective angular bins 708 which exceed threshold 710 may be determined to be points of a glass object/surface and may be localized as glass points 704. Accordingly, glass objects 712, comprising multiple glass points 704, may be placed on the computer-readable map 702. Glass objects 712 may comprise a special denotation on the computer-readable map 704, which represents area occupied by glass surfaces or objects. Localizing of glass objects 712 on the map 702 may be crucial for a robot 102 to operate using the map 702 by indicating to a controller 118 of the robot 102 that regions occupied by glass objects 712 are occupied by solid and impassible objects, which may be difficult to detect using a ToF sensor 202. Additionally, localizing points 204 beyond the glass objects 712 (i.e., on the other side of the glass) may, in some embodiments of robot 102, cause robot 102 to stop or slow down to avoid a detected object through the glass objects 712 if the glass objects 712 are not mapped onto map 702. Advantageously, localizing glass objects 712 may further configure controller 118 of the robot 102 to determine that localization of objects or points 204 behind (i.e., on an opposite side of) glass objects 712 may not be considered during obstacle avoidance or route planning, wherein controller 118 may not slow or stop the robot 102 upon detecting point(s) 204 behind glass objects 712.

For example, if a robot 102 navigating nearby an identified glass object 712 detects a moving body approaching it from an opposite side of the glass object 712 (i.e., on the other side of the glass object 712) using a ToF sensor 202 (e.g., based on beam 208-T shown in FIG. 3B reflecting off the moving body), the robot 102 may not anticipate slowing or stopping for the moving body as the moving body is behind a glass barrier.

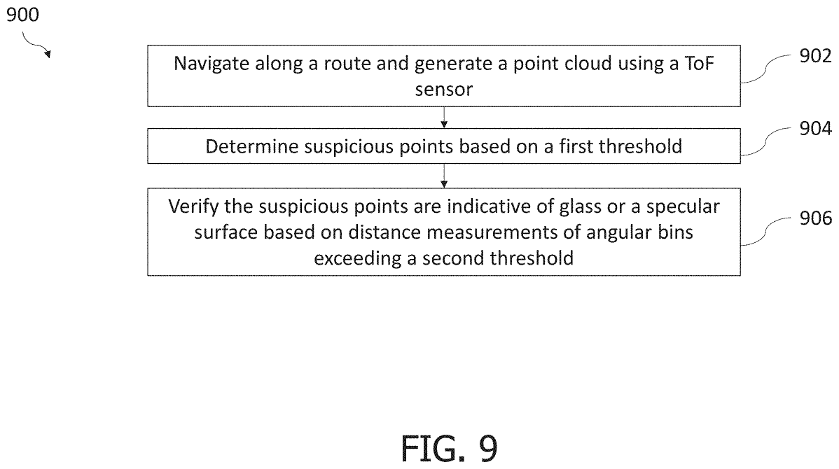

As another example, points 704 may localize specular surfaces not comprising glass using the same angular bin method discussed above and further elaborated in FIG. 9 below. In this example, the objects 712 may still comprise a special denotation from other objects localized using points 204 on the computer-readable map, wherein the robot 102 produces substantially fewer points 204 than expected when navigating nearby the objects 712. Accordingly, the robot 102 may utilize the computer-readable map to identify and localize the objects 712 (e.g., for obstacle avoidance) despite fewer points 204 being captured by a ToF sensor 202 of these objects 712.

According to at least one non-limiting exemplary embodiment, a controller 118 of a robot 102 may identify suspicious points 504 during navigation and later identify glass points 704 from the suspicious points 502 subsequent the navigation (i.e., upon generation of the entire computer-readable map 702). In some embodiments, the controller 118 may identify both the suspicious points 504 and glass points 704 subsequent navigation of a route. In some embodiments, the controller 118 may identify suspicious points 504 and populate the angular bins 708 as the robot 102 navigates a route and receives point cloud data from a ToF sensor 202.

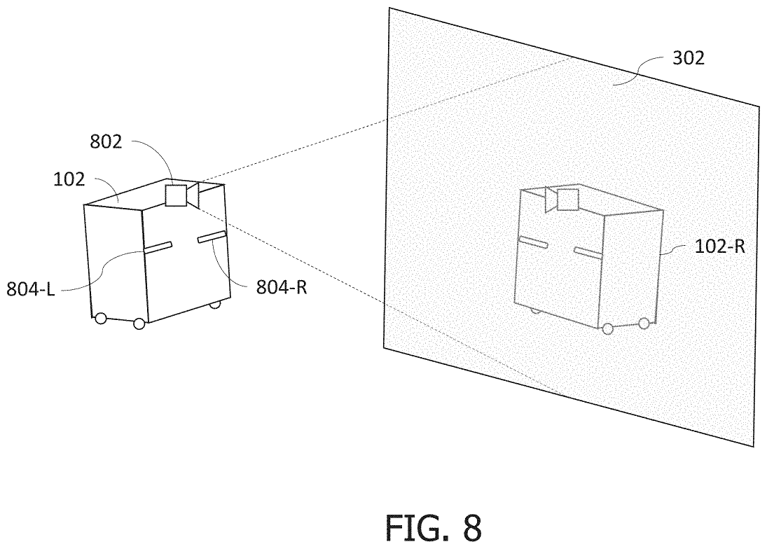

FIG. 8 illustrates a method for a robot 102 to detect glass 302 using an image camera 802 of sensor units 114, according to an exemplary embodiment. Glass 302 may similarly be illustrative of specular surfaces such as mirrors as appreciated by one skilled in the art given the contents of the present disclosure, wherein the object 302 being “glass” is intended to be illustrative and non-limiting. As illustrated in FIG. 3 above, ToF sensors may comprise limited capabilities of detecting glass 302 due to transmission of beams 208 through the glass 302. Similarly, ToF sensors may comprise limited capabilities for detecting specular surfaces due to specular reflection shown in FIG. 2B(ii). Accordingly, the imaging camera 802 may be also be utilized to detect glass 302 either as a verification step to the methods disclosed above or as a separate method for glass 302 detection.

The controller 118 of the robot 102 may navigate the robot 102 along a route (e.g., navigating towards one or more suspicious points 504) and capture images (e.g., RGB, greyscale, etc.) using imaging camera 802 which depict a surface of an object. In doing so, the controller 118 may expect, if the surface is glass or a specular surface, to observe a partial reflection of the robot 102 in the images of the surface. The controller 118 may utilize image processing methods (e.g., convolutional neural networks) to determine if the reflection of the robot 102-R is represented within images captured by the imaging camera 802.

In some embodiments, the robot 102 may further comprise visual indicators such as lights 804-L and 804-R disposed on the left and right sides of the robot 102, respectively. The controller 118 may blink or change a color of the lights 804-L and 804-R in a predetermined pattern. Detection of the reflection of the lights emitted from lights 804-L and 804-R may indicate the surface 302 is glass or a specular surface based on employing the inventive concepts discussed above with respect to FIG. 8. In some embodiments, the robot 102 may perform a predetermined sequence of motions, such as extending, retracting, or moving a feature of the robot 102 and detecting the extension or retraction within images from camera sensor 802. That is, the robot 102 may perform any visual display in front of an object represented by suspicious points 504 and, upon detecting the visual display within its refection 102-R using images from camera sensor 802, may determine the object is glass or a specular surface. It is appreciated by one skilled in the art that the method of using an imaging camera 802 may be additionally applied to highly reflective surfaces (e.g., metallic walls or mirrors), which may be further advantageous due to the difficulty of sensing a specular surface using a ToF sensor 202 as illustrated in FIG. 2B(ii).

FIG. 9 illustrates a method 900 for a controller 118 to detect glass 302 and/or specular surfaces, such as a highly reflective mirror, using a ToF sensor 202, according to an exemplary embodiment. It is appreciated that any steps of method 900 may be effectuated by a controller 118 executing computer-readable instructions from memory 120.

Block 902 comprises the controller 118 navigating a robot 102 along a route using a ToF sensor. In some embodiments, the navigation of the route may be performed under user supervision as a training procedure, wherein the user may push, pull, drive, lead, or otherwise move the robot 102 along the route. In some embodiments, the navigation is performed as an exploratory measure such that the robot 102 may localize objects within its environment to generate a computer-readable map. That is, the robot 102 may navigate the route for any reason, wherein memory 120 may comprise no prior localization data of objects, such as glass objects, within the environment.

Block 904 comprises the controller 118 determining suspicious points 504 based on a first threshold, such as angular threshold 502, 506 or distance threshold 602. In some embodiments, for example as illustrated in FIG. 5, the first threshold 502, 506 may comprise an angular range about a point 204, localized by the ToF sensor 202, where lack of detection of any other point 204 within the angular threshold 506 about the point 204 may indicate the point 204 comprises a suspicious point 504. In some embodiments, for example as illustrated in FIG. 6, the distance threshold 602 may be used, wherein distance threshold 602 may comprise a distance between two adjacent points 204, wherein two points 204 of two respective sequential scans separated by distance threshold 602 (with no other points 204 between the two points 204) may indicate the detected two points 204 are suspicious points 504.

Block 906 comprises the controller 118 verifying the suspicious points 504, identified in block 904 above, are indicative of glass or specular surface(s) based on distance measurements of angular bins 708 exceeding a second threshold 710, as illustrated in FIG. 7A-B above. Angular bins 708 may comprise a discretized angular range about a world origin 706. Each angular bin 708 may be populated with a summation of distances between suspicious points 504 encompassed within a respective angular bin 708 and the world origin 706. Upon the summation of distances for an angular bin 708 exceeding the second threshold value 710, all suspicious points 504 within the angular bin 708 are identified as localizing glass or specular surfaces.

According to at least one non-limiting exemplary embodiment, points identified as localizing glass or specular surfaces may be localized onto a computer-readable map with a special denotation or encoding. For example, objects 712 illustrated in FIG. 7C could be labeled as “glass object” or “specular surface”, or an equivalent.

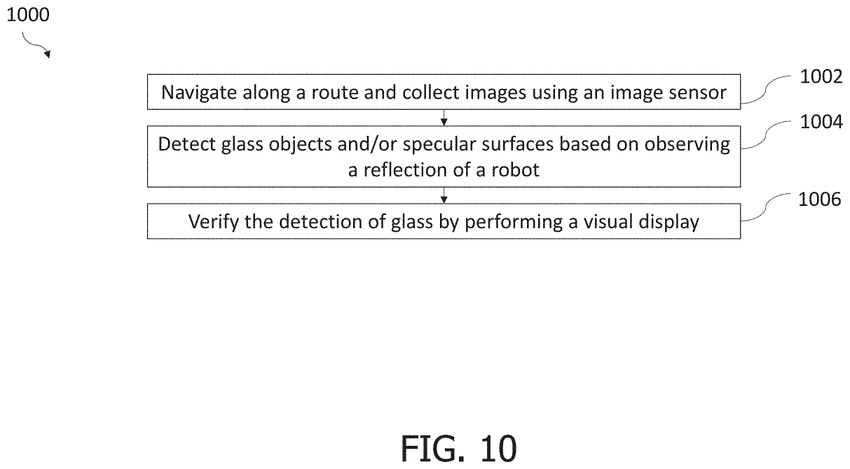

FIG. 10 illustrates a method for a controller 118 of a robot 102 to detect glass and/or specular surfaces using an image sensor 802 of sensor units 114, according to an exemplary embodiment. It is appreciated that controller 118 performing any steps of method 1000 may be effectuated by the controller 118 executing computer-readable instructions from memory 120.

Block 1002 comprises the controller 118 navigating the robot 102 along a route and collecting images using the image sensor 802. Image sensor 802 may comprise an RGB image camera or greyscale image camera. In some embodiments, the navigation of the route may be performed under user supervision as a training procedure, wherein the user may push, pull, drive, or otherwise move the robot 102 along the route. In some embodiments, the navigation is performed as an exploratory measure such that the robot 102 may localize objects within its environment to generate a computer-readable map. That is, the robot 102 may navigate the route for any reason, wherein memory 120 may comprise no prior localization data of objects, such as glass objects, within the environment.

Block 1004 comprises the controller 118 detecting glass objects based on observing a reflection of the robot 102. The controller 118 may execute specialized image recognition algorithms configured to detect the robot 102, and thereby its reflection, in images captured by the sensor 802. For example, the image recognition algorithms may implement a convolutional neural network or a trained model derived from a convolutional neural network. In other embodiments, the image recognition algorithm may compare captured images to images of a library, the library containing images of the robot 102. By comparing captured images to images of the library, the controller 118 may determine if the robot reflection is present in the captured images if the captured images and images of the library are substantially similar (i.e., greater than a threshold). One skilled in the art may envision a plurality of other contemporary image/pattern recognition algorithms may also be used, without limitation. If the controller 118 receives an image of the robot 102 (i.e., its reflection in a reflective or glass surface), the controller 118 may localize an object which produces the image of the robot 102 onto a computer-readable map as a “glass object” or a “specular surface”, or equivalent definition. The localization may be performed using the sensor 802 and/or other sensor units 114.

Block 1006 comprises the controller 118 verifying the detection of the glass or specular surface by configuring the robot 102 to perform a visual display. The visual display may comprise, for example, a predetermined sequence of movements (e.g., shake left to right 5 times), blinking of lights (e.g., lights 804-L and 804-R) in a predetermined pattern, moving a feature of the robot 102 (e.g., waving a robotic arm, lever, member, support), or any other movement or visual indication. In some embodiments, the robot 102 may perform a predetermined sequence of motions, such as, extending, retracting, or moving a feature of the robot 102 and detecting the extension or retraction within images from camera sensor 802. The visual display performed by the robot 102 occurs proximate the identified glass object or specular surface such that a reflection may be detected by imaging sensor 802. The visual display, when detected by images from sensor 802, confirm to the controller 118 that an image received by sensor 802 comprising the robot 102 represented therein which causes the detection of the glass object or specular surface in block 1004 is, in fact, a reflection of the robot 102, and not another robot 102 of the same make/model.

Advantageously, method 1000 may enable a robot 102 to verify objects identified as glass or specular objects (e.g., objects 712 of FIG. 7C) are in fact glass or specular objects. In some instances, methods 900 and 1000, or parts thereof, may be performed concurrently, such as during a single training run or exploratory run. For example, point clouds may be generated as in block 902 while images are gathered as in block 1002 while the robot navigates a route in a single training run. If suspicious points are determined (block 904) and verified that they are indicative of glass (block 906), the controller 118 may execute blocks 1004 and 1006 of method 1000 while the robot is still in proximity to the glass objects indicated in block 906. One can appreciate that concurrent execution of methods 900 and 1000 in this manner may be best utilized such as within small environments (e.g., a single room) comprising few glass or specular objects.

In other instances, methods 900 and 1000 may be executed separately but sequentially. For example, one skilled in the art may appreciate that method 1000 may take a substantial amount of time to verify all glass and specular objects within large environments (e.g., an entire building). Accordingly, the method 1000 may be executed subsequent to method 900 as a verification step to ensure glass or specular objects were identified correctly in method 900. For example, the controller 118 may configure the robot to execute a route through the environment in block 1002 that navigates the robot directly to putative glass objects identified in block 906 and execute blocks 1004 and 1006 for verification. In instances of multistory buildings where some floors may have similar floor plans, the controller may determine that some glass objects identified in block 906 in one floor are substantially similar to those identified in other floors and not verify them by method 1000. The controller may execute a route in block 1002 to navigate the robot only to dissimilar putative glass objects for verification in blocks 1004 and 1006.

It will be recognized that while certain aspects of the disclosure are described in terms of a specific sequence of steps of a method, these descriptions are only illustrative of the broader methods of the disclosure, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the disclosure disclosed and claimed herein.

While the above detailed description has shown, described, and pointed out novel features of the disclosure as applied to various exemplary embodiments, it will be understood that various omissions, substitutions, and changes in the form and details of the device or process illustrated may be made by those skilled in the art without departing from the disclosure. The foregoing description is of the best mode presently contemplated of carrying out the disclosure. This description is in no way meant to be limiting, but rather should be taken as illustrative of the general principles of the disclosure. The scope of the disclosure should be determined with reference to the claims.

While the disclosure has been illustrated and described in detail in the drawings and foregoing description, such illustration and description are to be considered illustrative or exemplary and not restrictive. The disclosure is not limited to the disclosed embodiments. Variations to the disclosed embodiments and/or implementations may be understood and effected by those skilled in the art in practicing the claimed disclosure, from a study of the drawings, the disclosure and the appended claims.

It should be noted that the use of particular terminology when describing certain features or aspects of the disclosure should not be taken to imply that the terminology is being re-defined herein to be restricted to include any specific characteristics of the features or aspects of the disclosure with which that terminology is associated. Terms and phrases used in this application, and variations thereof, especially in the appended claims, unless otherwise expressly stated, should be construed as open ended as opposed to limiting. As examples of the foregoing, the term “including” should be read to mean “including, without limitation,” “including but not limited to,” or the like; the term “includes” should be interpreted as “includes but is not limited to”. The term “comprising” as used herein is synonymous with “including,” “containing,” or “characterized by,” and is inclusive or open-ended and does not exclude additional, unrecited elements or method steps; the term “having” should be interpreted as “having at least;” the term “such as” should be interpreted as “such as, without limitation. The term “example” or the abbreviation “e.g.” is used to provide exemplary instances of the item in discussion, not an exhaustive or limiting list thereof, and should be interpreted as “example, but without limitation”. The terms “illustration”, “illustrative” and the like should be interpreted as “illustration, not limitation”. Adjectives such as “known,” “normal,” “standard,” and terms of similar meaning should not be construed as limiting the item described to a given time period or to an item available as of a given time, but instead should be read to encompass known, normal, or standard technologies that may be available or known now or at any time in the future; and use of terms like “preferably,” “preferred,” “desired,” or “desirable,” and words of similar meaning should not be understood as implying that certain features are critical, essential, or even important to the structure or function of the present disclosure, but instead as merely intended to highlight alternative or additional features that may or may not be utilized in a particular embodiment. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should be read as “and/or” unless expressly stated otherwise. The terms “about” or “approximate” and the like are synonymous and are used to indicate that the value modified by the term has an understood range associated with it, where the range may be ±20%, ±15%, ±10%, ±5%, or ±1%. The term “substantially” is used to indicate that a result (e.g., measurement value) is close to a targeted value, where close may mean, for example, the result is within 80% of the value, within 90% of the value, within 95% of the value, or within 99% of the value. Also, as used herein “defined” or “determined” may include “predefined” or “predetermined” and/or otherwise determined values, conditions, thresholds, measurements, and the like.

What is claimed is:

1. A method for detecting an object, comprising:
collecting measurements using a sensor as a robot navigates along a route in an environment, the measurements comprising a plurality of points localized on a computer readable map;
identifying one or more first points of the collected measurements based on a first threshold;
identifying one or more of the first points of the measurement as an object based on a second threshold value, the object comprises either a glass or specular surface; and
updating the computer readable map to comprise the object in the environment.

2. The method of claim 1, further comprising:
discretizing the computer readable map into a plurality of angular bins, each angular bin comprising an arc length defined about an origin, the origin comprising a fixed point within the environment;
populating each angular bin of the plurality of angular bins with a summation of distances between the one or more first points encompassed therein and the origin; and
comparing the summation of distances for each angular bin to the second threshold value, the one or more first points encompassed within each angular bin are identified as representing the object upon the summation of distances exceeding the second threshold value for a respective angular bin.

3. The method of claim 2, wherein the first threshold comprises an angular range, the angular range being centered about each point of the plurality of points, each point is one of the one or more first points if it is the only point within the angular range, the angular range being larger than the angular resolution of the sensor.

4. The method of claim 3, wherein the first threshold corresponds to a value of spatial separation between points of a first scan and points of a second scan, a point of the first scan and a nearest point of the second scan separated by at least the spatial separation are included in the one or more first points, the second scan being captured subsequent the first scan by the sensor.

5. The method of claim 1,
wherein the one or more identified first points are separated apart from each other at a greater distance compared to separation between other points of the plurality of points, the first points corresponding to the object and the other points corresponding to another object, the another object corresponding to non-glass or non-specular surface, and
wherein the one or more identified first points include a density lower than density of the other points of the plurality of points.

6. The method of claim 1, further comprising:
navigating the robot to the object based on the computer readable map; and
utilizing a camera sensor to detect a reflection of the robot to verify the object comprises glass or a specular surface.

7. The method of claim 6, further comprising:
performing a visual display upon navigating the robot to the object; and
detecting a reflection of the visual display using the camera sensor to verify the object comprises glass or a specular surface.

8. The method of claim 1, wherein,
the identification of the one or more first points is performed after the robot has navigated the route based on the computer readable map generated at least in part during navigation of the route.

9. The method of claim 3, wherein,
the identification of the one or more first points is performed after the robot has navigated the route based on the computer readable map generated at least in part during navigation of the route.

10. The method of claim 4, wherein,
the identification of the one or more first points is performed after the robot has navigated the route based on the computer readable map generated at least in part during navigation of the route.

11. A non-transitory computer readable storage medium comprising a plurality of computer readable instructions embodied thereon, that when executed by at least one processor, configure the at least one processor to,
collect measurements using a sensor as the robot navigates a route, the measurements comprising a plurality of points localized on a computer readable map;
identify one or more first points of the measurements based on a first threshold;
identify one or more of the first points of the measurement as an object based on a second threshold value, the object comprises either glass or specular surfaces; and
update the computer readable map to comprise the object.

12. The non-transitory computer readable storage medium of claim 10, further comprising computer readable instructions that configure the at least one processor to:
discretize the computer readable map into a plurality of angular bins, each angular bin comprising an arc length defined about an origin, the origin comprising a fixed point within an environment;
populate each angular bin of the plurality with a summation of distances between each of the one or more first points encompassed therein and the origin; and
compare the summation of distances for each angular bin to the second threshold value, the one or more first points encompassed within each angular bin are identified as representing object upon the summation of distances exceeding the second threshold value for a respective angular bin, the object comprising glass or a specular surface.

13. The non-transitory computer readable storage medium of claim 12, wherein the first threshold comprises an angular range, the angular range being centered about each of the plurality of points, each point is determined to be one of the one or more first points if it is the only point within the angular range, the angular range being larger than the angular resolution of the sensor.

14. The non-transitory computer readable storage medium of claim 12, wherein the first threshold corresponds to a value of spatial separation between points of a first scan and points of a second scan, a point of the first scan and a nearest point of the second scan separated by at least the spatial separation are included in the one or more first points, the second scan being captured subsequent the first scan by the sensor.

15. The non-transitory computer readable storage medium of claim 11,
wherein the one or more identified first points are separated apart from each other at a greater distance compared to separation between other points of the plurality of points, the first points corresponding to the object and the other points corresponding to another object, the another object corresponding to non-glass or non-specular surface, and
wherein the one or more identified first points include a density lower than density of the other points of the plurality of points.

16. The non-transitory computer readable storage medium of claim 11, further comprising computer readable instructions that configure the at least one processor to:
navigate the robot to the objects based on the computer readable map; and
utilize a camera sensor to detect a reflection of the robot to verify the object comprises glass or a specular surfaces.

17. The non-transitory computer readable storage medium of claim 16, further comprising computer readable instructions that configure the at least one processor to:
perform a visual display upon navigating the robot to the object; and
detect a reflection of the visual display using the camera sensor to verify the object comprise glass or a specular surfaces.

18. A method for detecting an object by a robot, comprising:
collecting one or more images using a camera sensor as the robot navigates a route in an environment;
detecting a reflection of the robot within the one or more images;
performing a visual display; and
detecting the visual display within the one or more images collected from the camera sensor,
wherein the detection of the visual display corresponds to detection of the object, wherein the object comprises a glass object or a reflective surface.

19. The method of claim 18, wherein the visual display comprises at least one of the, (i) blinking or changing colors of one or more lights, or (ii) moving a feature of the robot.

20. The method of claim 18, wherein the detection of the reflection comprises use of an image recognition algorithm to identify images comprising of, at least in part, the robot.
